(19) United States
(12) Patent Application Publication
(10) Pub. No.: US 2002/0049847 A1
(43) Pub. Date: Apr. 25, 2002

(54) Dynamic interactive processes for unaided browsers

(75) Inventors: Wendy C. McArdle, Burlingame, CA (US); Val D'Souza, Santa Clara, CA (US); Daniel Lo, San Francisco, CA (US)

Correspondence Address: M. Conrad Huffstutler, Jr., PO Box 389, Liberty Hill, TX, 78642, US

(73) Assignee: CardBlast.com

(21) Appl. No.: 09/841,706

(22) Filed: Apr. 24, 2001

Related U.S. Application Data
(60) Provisional application No. 60/199,730, filed on Apr. 24, 2000.

(51) Int. Cl. G06F 15/16

(52) U.S. Cl. 709/227; 709/218; 709/206

(57) ABSTRACT

A method and computerized system for creation, assembling, sending, exchanging and receiving of digital images via an unassisted web browser is disclosed. The method facilitates secure collaborative work between separated individuals across the internet.

### CROSS REFERENCE TO RELATED APPS

This application claims the priority of U.S. Prov. App. No. 60/199730 filed Apr. 24, 2000.

### BACKGROUND

1,0 Typical networks and browsers, especially internet (www) and browsers such as Netscape (tm) or Internet Explorer (tm) can be used to display interactive objects which consist of graphic files, text files and code packets which provide primitive levels of selection of fixed graphics, i.e., insert or remove.

1,1 There is a long-felt need for server software to incorporate efficient algorithms which allow dynamic interchange of various media types (audio, video, animation, etc.,) and for collaborative interactions of multiple co-creators. Dynamic interactive programs/sites typically include computer games with various levels of realism re characters/environment/plot. However, simple action options such as shoot or reverse direction are not suitable for complex creative interchanges ;as may occur between: (a) a design team or (o) a presenter and his audience.

1,2 While independent complimentary programs called helpers and plug-ins have been developed to augment both the interchange and interactive capabilities of browsers, especially Netscape, many users refuse to use them because of concerns about the problems such code may introduce into their computer operating system-hardware function, i.e., memory resource waste/usage and unexplained crashes in certain Windows applications/peripheral drivers.

1,3 Sophisticated users, especially those who regularly work with graphic design, rendering or CAD programs which can make dynamic and parametric modifications of 3D images-wireframes cannot work together with simplistic interactive limitations typical of current children's video games.

1,4 A robust, compact set of code applets (Java, Perl, CGI scripts) mounted on the site server can reliably emulate important graphics dynamic manipulation functions of computer objects defined in its own repertoire and thereby allow rapid, productive, user-friendly interactions between graphic designers over the network. The present invention is a method of site-unique, dynamic code packages which receive user-browser input and facilitate rapid, accurate drag-and-drop, DnD, placement on a message being created. The site-unique code used in the present invention consists of two parts: (a) adaptation of known commands in Java, JavaScript, Perl, CGI, etc., to accomplish creation of an image from a database of preselected elements and (b) customized application interfaces which are adaptive to browsers of different suppliers/vintages and permit the user to change certain styles of the database elements and add new text or graphic elements. The site-unique algorithms form dynamic layers on the fly to accommodate DnD features for text and graphics. The algorithms further provide a local database for long-term retention of every or selected client session or activities. Data retained in this site database allows the image recipient to engage all the distinctive features, objects, and layers of the image created or modified by the original user. Typical greeting-card websites allow a visitor to select a single background and combine this with a message and send a unchangeable message to a recipient.

1,4,1 Known CSS1 features/commands. Cascading style sheets (CSS) may be used by programmers in the preparation of web pages to be displayed on version4 browsers. The code and related processes are monitored by WC3 organization and is now at the draft version 1, hence the nomenclature CSS1. In general the page designer can control margins, text font, text color and text borders with CSS methodologies. This technology is useful mainly to webmasters and page stylists who desire to make significant visual changes to the appearance of a page. The specific underlying code, commands and arguments are highly complex and subject to frequent changes/updating. In Netscape Navigator 4, Java Script Style Sheets (JSS) can be used to introduce linked changes and CSSI allows creation subsets of each style. Because of these considerations, CSS 1 methods used to prepare the site are not available to any client or visitor. Typically, extensive use of plug-ins and programs is required to achieve even modest degrees of interaction with a user.

1,4,2 Known CSS-P features/commands for layers and positioning. Both Navigator4 and Explorer4 browsers implement the WC3 draft version of CSS-P which allows a page to employ a predetermined number of layers each of which contains an image. The number of layers is fixed at page creation by the designer and the user is not able to create any new layers or related duplicate/new images of those available. Each layer exists in its own physical layer, i.e., parameters x,y relate to width and height, i.e., its 2D position coordinates; the 3D dimension is prescribed by z-order, or z Index location in the stack. Navigator4 recognizes layer and NewLayer( ) commands.

The image creation methods of the present invention are based upon use of alternative programming languages such as Perl to handle user-initiated new layer dynamic generation and user-defined placement of new images. The present method also allows the user to delete a layer or image as an editing step of the image. Site-unique algorithms automatically manage entry and deletion of records into a stored, user-specific database which is then used to display, transmit the message or image and to provide a platform for subsequent modifications and additions.

1,4,3 Custom Application Interfaces for rapid, accurate DnD—using browser controls only.

The method of the present invention differs from mere application of current- standard CSS-1 and CSS-P in the following ways:

(a) the user is allowed to create or delete layers from their workspace (this is not possible in CSS-P which fixes each element into a static layer)

(b) the user can achieve a broad range of visual control of image elements using only browser features/controls (server access and underlying page code changes are not necessary)

(c) the user creates images into dynamic layers which are stored into a predetermined database and available to access by the original-creator user or designated recipient.

1,5 No website or any published patent document could be found which displays or discloses a method or system to accomplish complex graphic manipulation with an unaided browser.

### 2,0 BRIEF SUMMARY OF INVENTION

2,1 Overview.

The present invention is an on-line system for dynamic “what you see is what you get” interactive graphic image creation site which connects multiple, separated network users. Typically, the users interact sequentially either to create a new image (to be sent to others for editing—comments) or to edit modify/comment upon a received/previously-edited image. The system includes several key elements including stored stock-image files (line art or continuous-tone), stored user contact data files and interactive creation-manipulation programs resident in the site. These site-unique algorithms cooperate directly with the browser and facilitate selection of graphic elements e.g., frames and frames within frames, translation, rotation, replication, placement-anchoring, changing vertices of a selected line-segment/-spline curve, changing a selected fill (color or pattern), changing scale, adding text notes, changing font-face of text, adding animation or video in a window, adding automatic audio effects, adding programmable audio effects with a control display. The system stores newly-created/modified/augmented display-files in a secure database on the site server and provides: (a) notification to intended recipient that a “new” image has been forwarded and (b) provides an invitation to recipient to undertake new changes/additions and return the results back to the server database for specific actions, e.g., send to sender, send to other recipients, store, store offline to archive.

2,2 Browser Interactions.

The site-unique algorithm detects critical browser-ID info (version, setup, MS or non-MS operating system, memory, modem speed, etc.) and provides services from its repertoire appropriate to the capabilities of the detected browser.

2,3 Security.

Each creation or editing session produces a file of objects and their properties which is secured at the website and can be provided to other network users only by entering and validation of user-ID codes.

2,4 User Interface and Functionality.

The site-unique algorithms use many known mouse-down pointer icons- displays familiar to newbies and professionals to avoid errors, delays and frustration.

2,5 Website Tutorial/Help/Trouble Shooting.

The website of the present invention includes a comprehensive online tutorial, help index and trouble-shooting guide. The online tutorial is a visual user guide to creating, editing images from predefined backgrounds and elements; sections also conduct the user through procedures for uploading custom backgrounds and elements for use on the website. The searchable online help index includes visual and text assistance on site issues; the information is indexed both by keyword and general topic. The trouble-shooting pages display information on already-known site issues and FAQ (frequently asked questions); the help section also provides an input mechanism for users to ask new questions and report site problems.

2,6 Unique Features.

The site-unique algorithms of the present invention provide intuitive menus to select novel functions available only on this website. The present website system is unique in that it allows and facilitates drag and drop (DnD) placement of components with an unaided browser such as Netscape or Internet Explorer, i.e., without the use of plug-in graphic-handling programs coupled to the browser. The novel functions provide the user a DnD method of selecting and positioning artistic components and thereby to create a unique image and, if desired, coordinated with animation and audio effects.

### 3,0 BRIEF DESCRIPTION OF DRAWINGS

FIGS. 1(a) to (l), includes 14 BW representations of typical images or website display pages from the internet site CardBlast.com. These figures indicate a typical sequence of what a user or visitor would see in color as selections and inputs are provided to the series of site prompts. This series is typical for creation and sending of a created card including selection of background, elements, text and a sender message.

FIGS. 2(a) to (b) includes 2 BW representations of typical images or website display pages for creation and sending of a OuickCard. As for FIG. 1, the user or website visitor would see these images or pages in color. As can be seen, FIG. 2(b) also contains an option to go the creation sequence depicted in FIG. 1.

FIGS. 3(a) to (j) includes 10 BW representations of typical password accessible webmaster or site administrator display screens from the internet site CardBlast.com. These pages display the status and administrative control settings for each major area of the website. As is shown, the a variety of options are available on the several pages: “update” the webmaster may add/or change, “delete” the webmaster may remove, archive to another memory store/location, or delete, “viewdit” the webmaster view, add, change, edit or remove existing choices presented to users, “park” or put into parked or temporary stored memory and “display status”, text style (font, size, and color) may be changed or specified by the controls shown in FIG. 3(c) and the display sequence of choices is shown in FIGS. 3(d) to 3(p).

FIGS. 4(a) to (c) presents a typical block diagram to illustrate the image-creation portion of the present method; in this formal the portions have been separated to allow presentation on 3 letter-size sheets. This particular sequence of client or user steps and outcomes is taken from the internet site CardBlast.com and reflects one embodiment of the present method. When viewed together, these diagrams indicate diagrammatically the sequence of steps and decisions made by a typical visitor or site client in the creation process on this site, i.e., possible steps from the beginning to the send step (see bottom of FIG. 4(c) in this embodiment.

FIGS. 5(a) and (b) present a typical block diagram to illustrate the user or client perspective of the “sending” portion of the present method. This particular sequence of client or user steps and outcomes is taken from the internet site CardBlast.com and reflects one embodiment of the present method. When viewed together, these diagrams indicate diagrammatically the sequence of steps and decisions made by a typical visitor or site client in the process of establishing the recipient and sending the created card and message on this site, i.e., possible steps from the typical creation stage to the “sending” stage in this embodiment.

FIG. 6 presents a typical block diagram to illustrate the server perspective of the “sending” portion of the present method. This particular sequence of server process steps and outcomes is taken from the internet site CardBlast.com and reflects one embodiment of the present method. This diagram indicates diagrammatically the sequence of steps and decisions made by a typical server embodiment in the process of establishing the recipient and sending the created card and message on this site, i.e., possible steps from the typical creation stage to the “sending” stage in this particular embodiment.

FIG. 7 presents a typical block diagram to illustrate the client or recipient perspective of the “receiving” portion of the present method. This particular sequence of user or recipient response steps and outcomes is taken from the internet site CardBlast.com and reflects one embodiment of the present method. This diagram indicates diagrammatically the sequence of steps and decisions to be made by a typical card or message recipient who has been designated by a typical user of the CardBlast website. As can be seen, the recipient is invited or prompted to respond by creating a response card which includes all the options available to the original sender.

FIG. 8 presents a typical block diagram to illustrate the server perspective of the “receiving” portion of the present method. This particular sequence of server process steps and outcomes is taken from the internet site CardBlast.com and reflects one server embodiment of the present method. This diagram indicates diagrammatically the sequence of steps and decisions made by a typical server embodiment in the process of sending the created card or message to a designated recipient and, at receipt, prompting the receiver for a reply. As can be seen, the server in this embodiment prompts the recipient to edit the sender's card and images as a reply option.

### 4,0 DETAILED DESCRIPTION

4,1 Overview.

The system of the present invention includes the following main elements:

(a) Network with server and firewalls

(a1) electronic-computer server including databases, stored files containing text and graphic data, stored algorithms for executing a collection of predetermined functions callable by commands from users, said functions including text and image manipulation and messaging between network users

(a2) a firewall system to protect server data and algorithms from hacking by intruders

(b) Cadre of network-connected users including professional and casual subtypes, each user having unique site-assigned ID data which may be provided upon request for entry into a firewall zone.

(b1) Professional users include the webmaster, and designated database administrator users who have full access, i.e., to modify, add, delete, change passwords, etc. to the programs, subroutines, related databases and portions of the site displayed to casual users.

(b2) Casual users who access the website and certain selected resident programs via a browser are able to upload a limited number of selected graphic elements, i.e., a predetermined subset, to their personal database but have no general privilege to edit the main database.

(c) Display of selectable creation or editing topics/modes

(d) Display of selectable creation-modification activities including import of new user-supplied image

(e) Dynamic-interactive what-you-see-is what-you-get screen display of creation activity

(f) Display of selectable disposition options for created-modified images

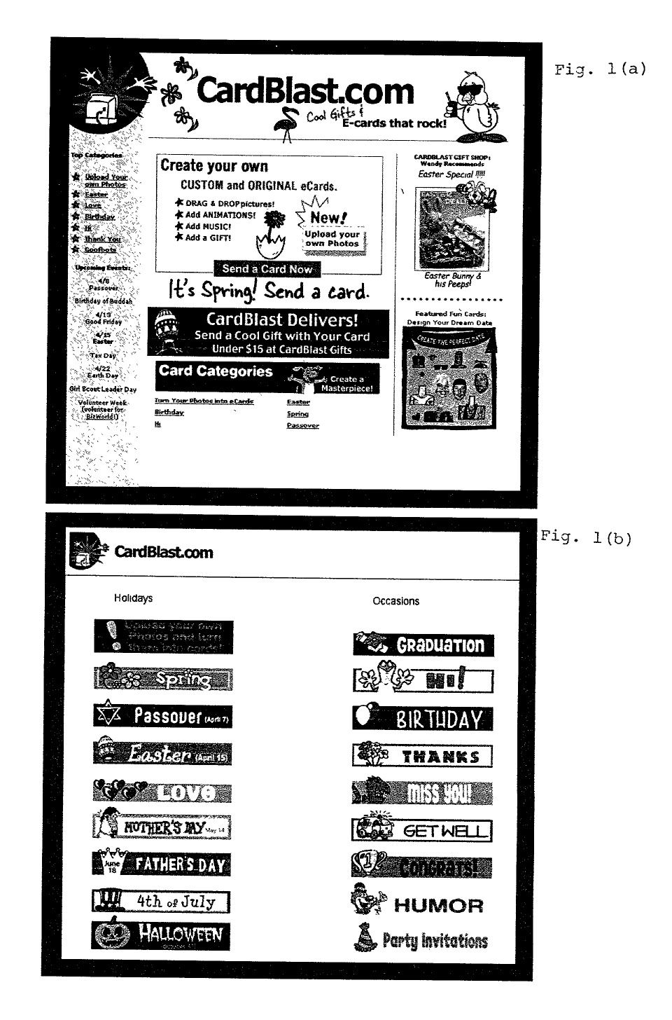

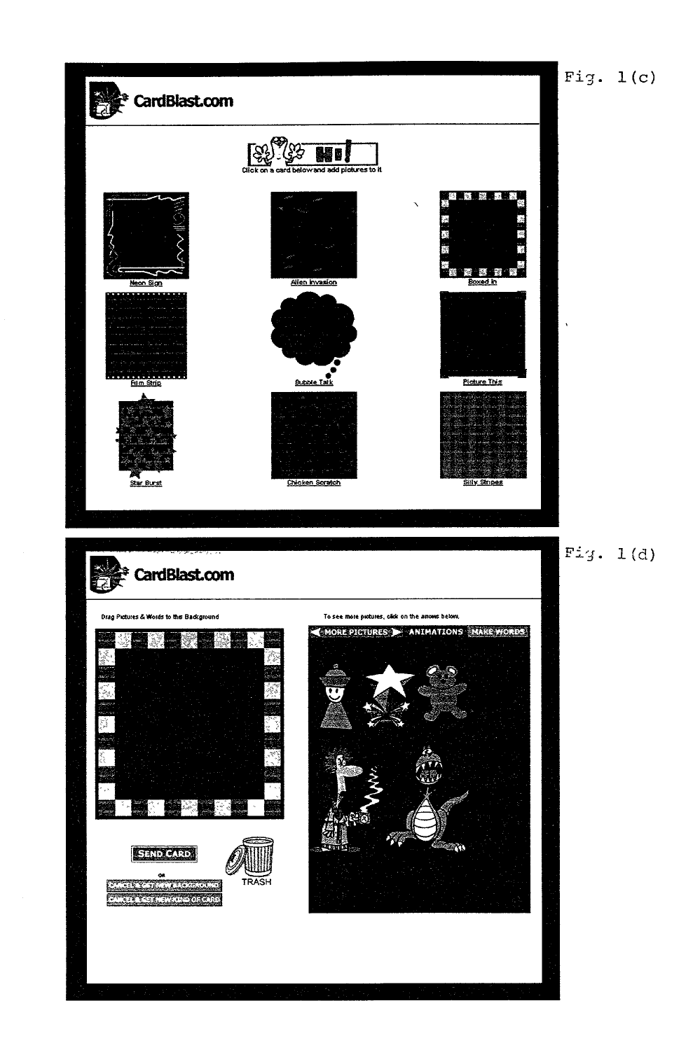

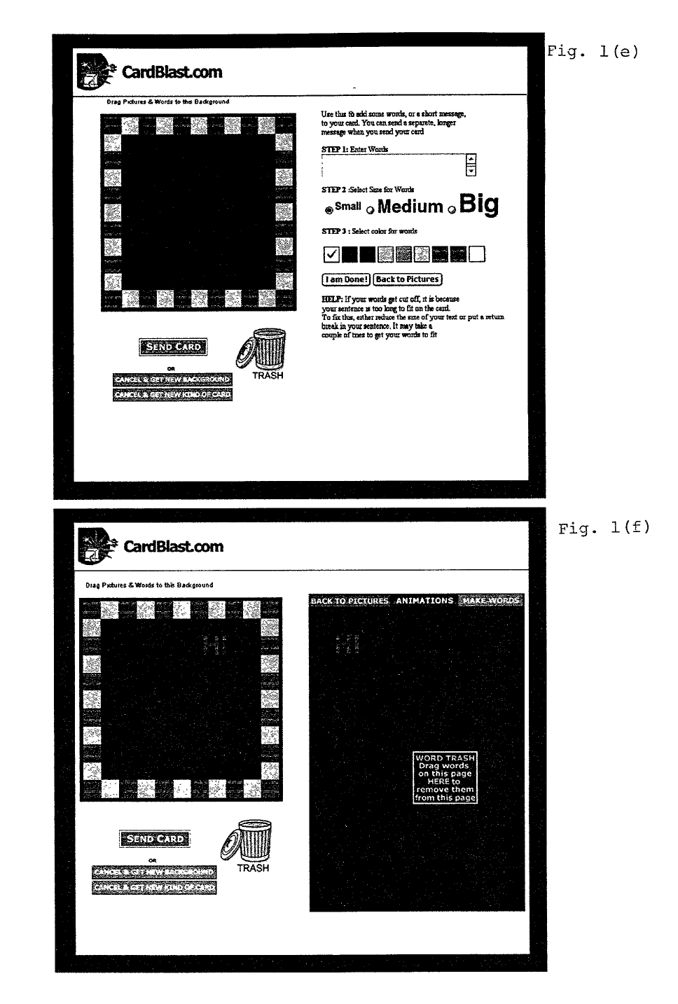

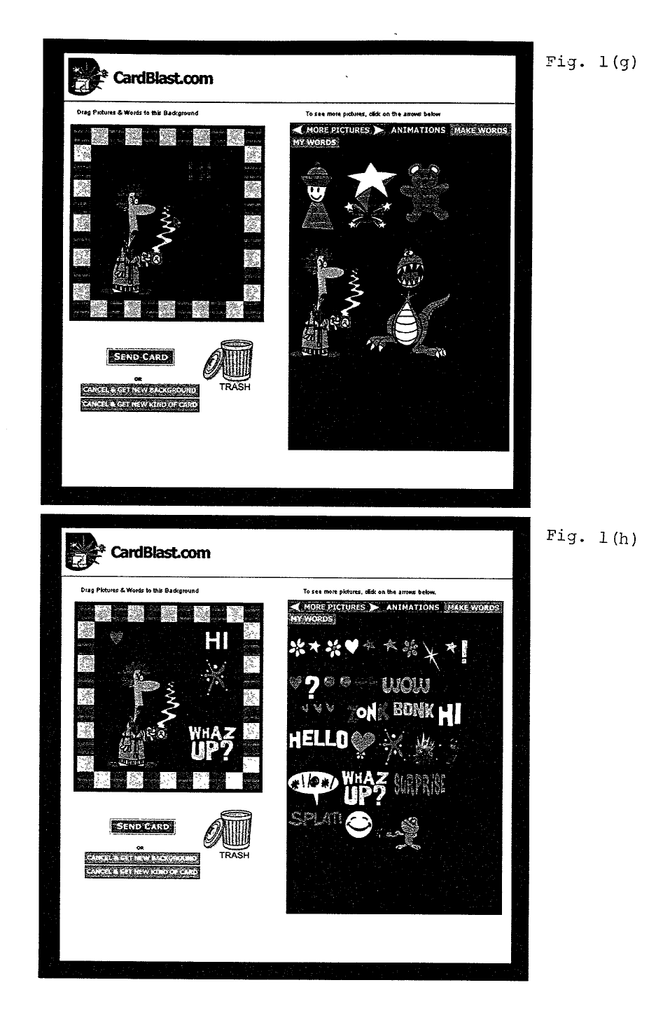

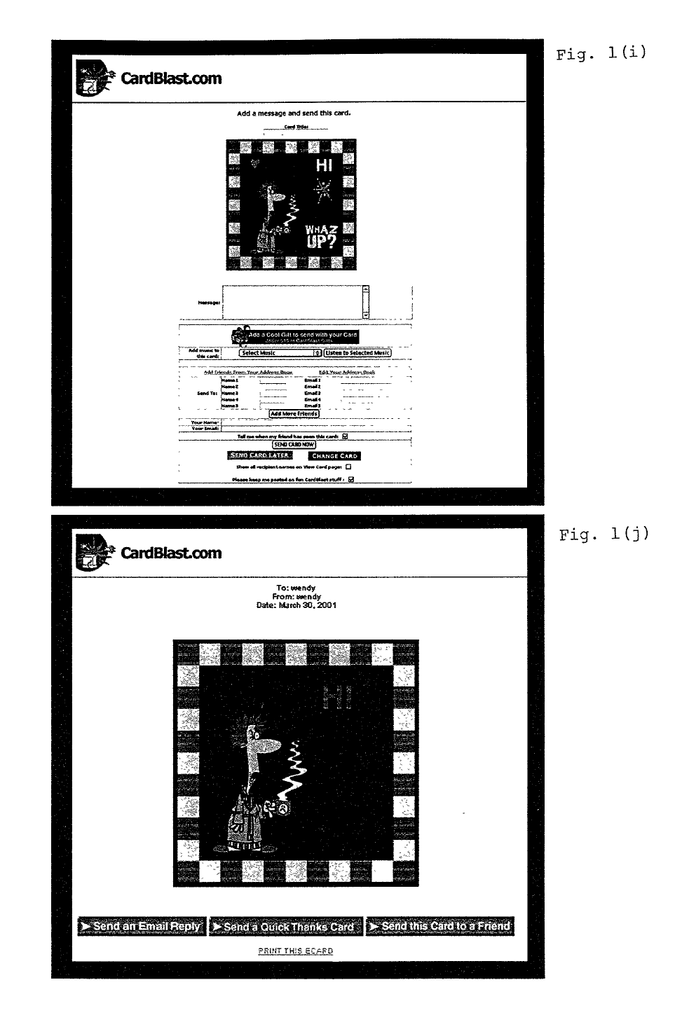

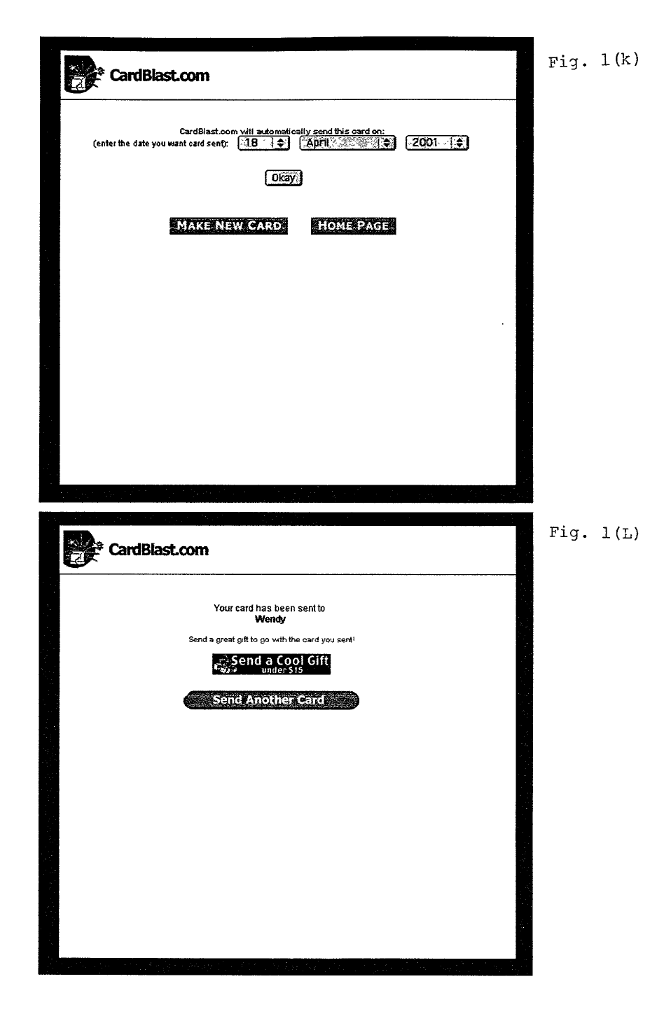

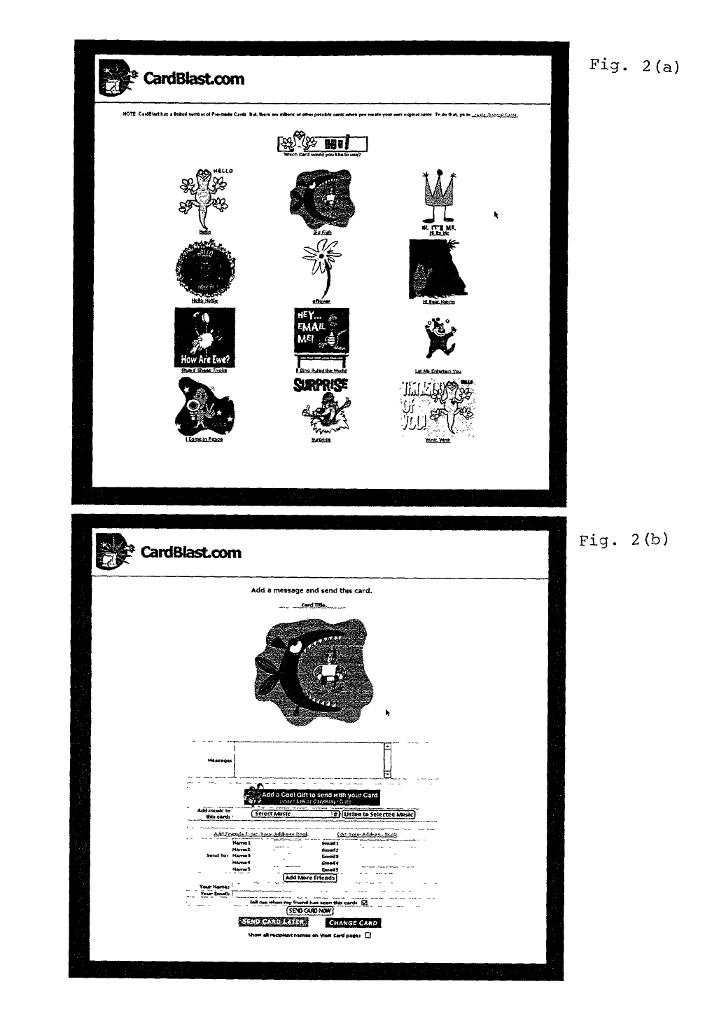

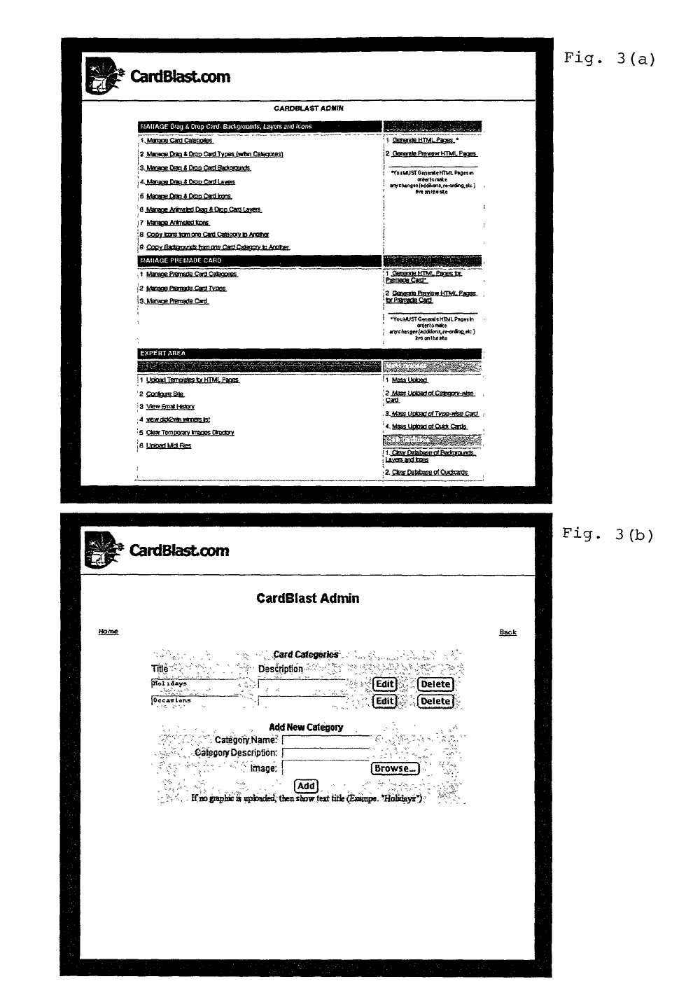

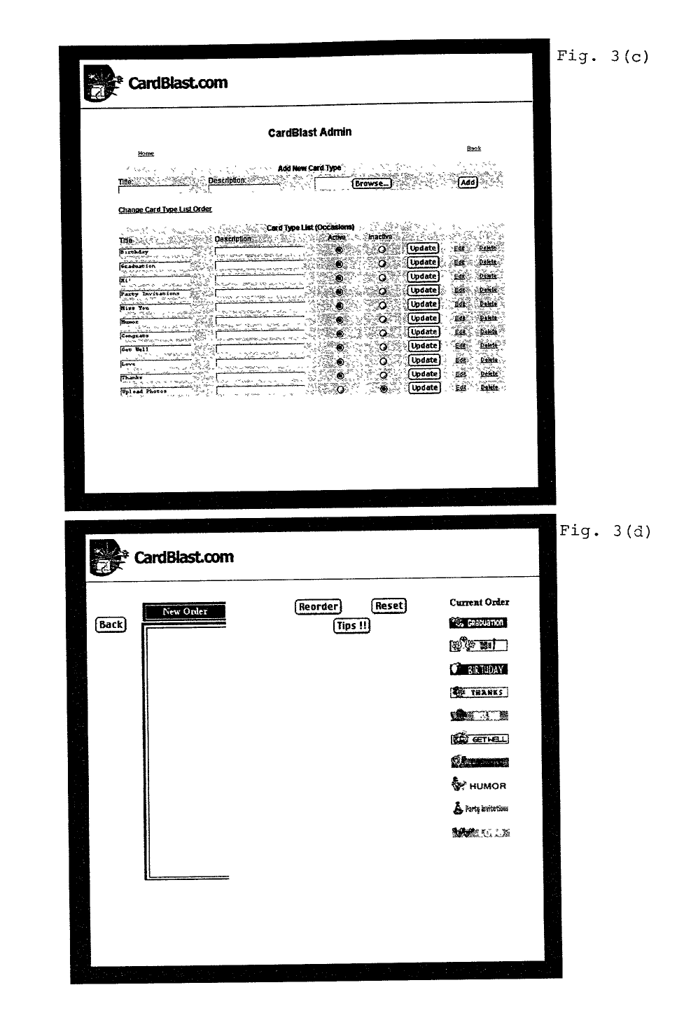

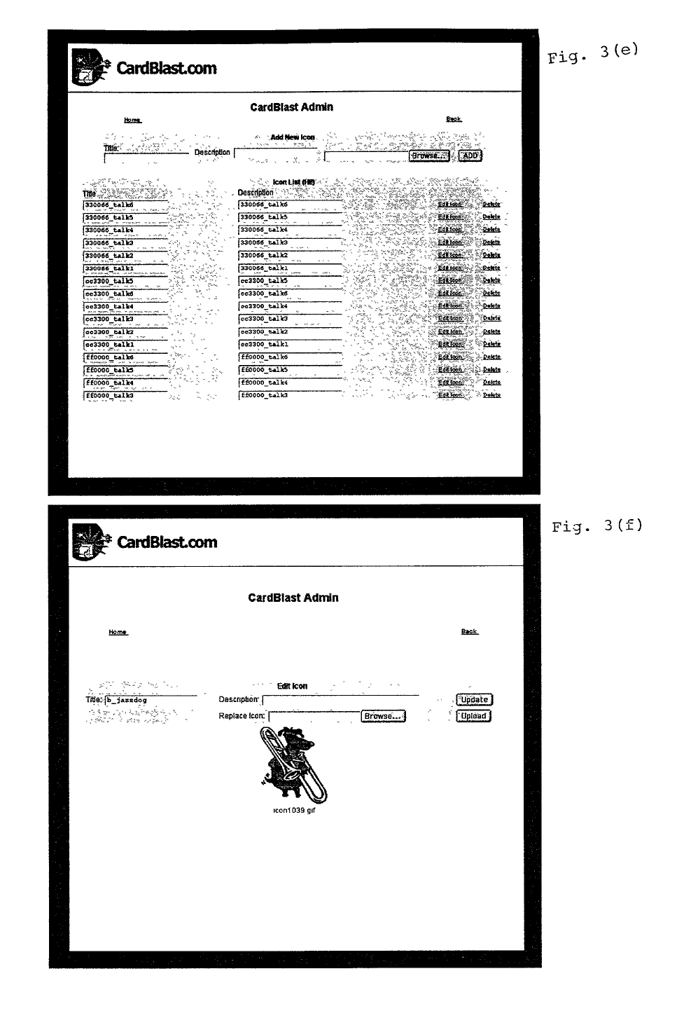

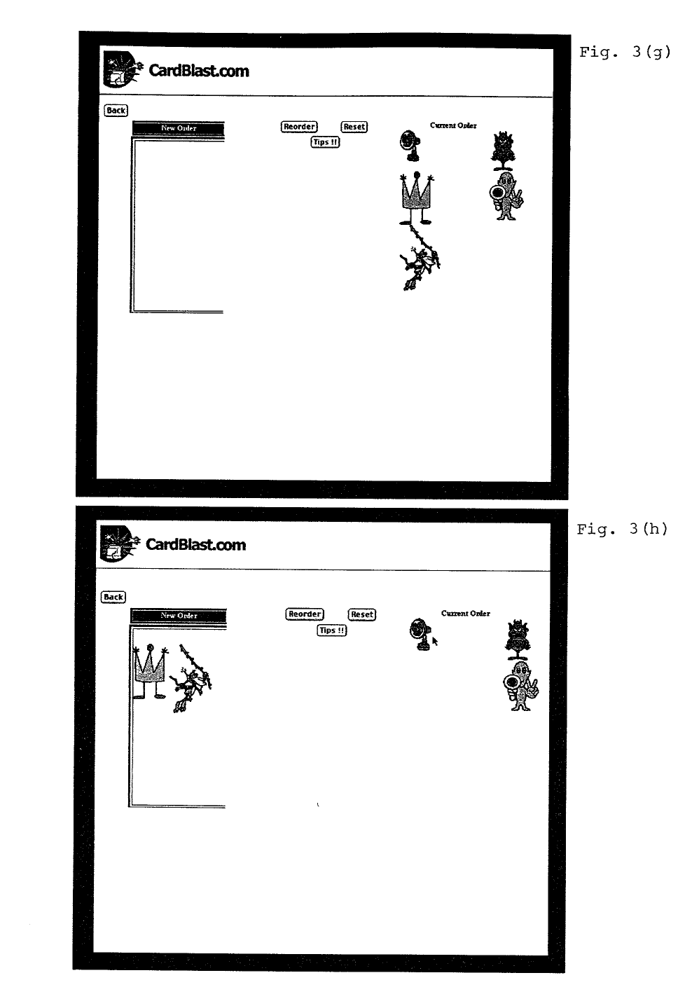

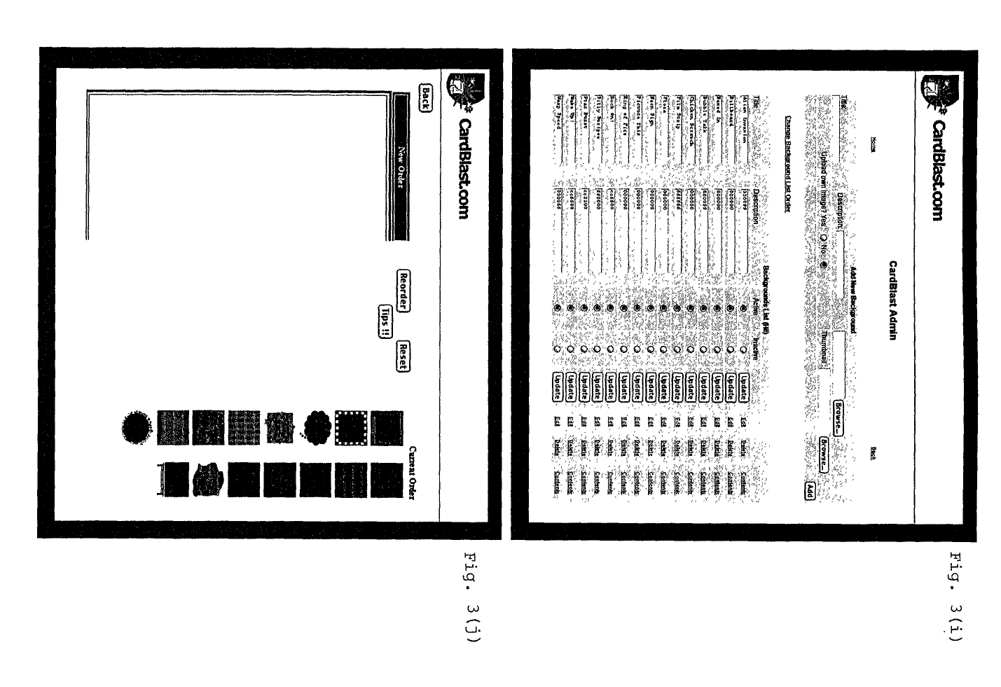

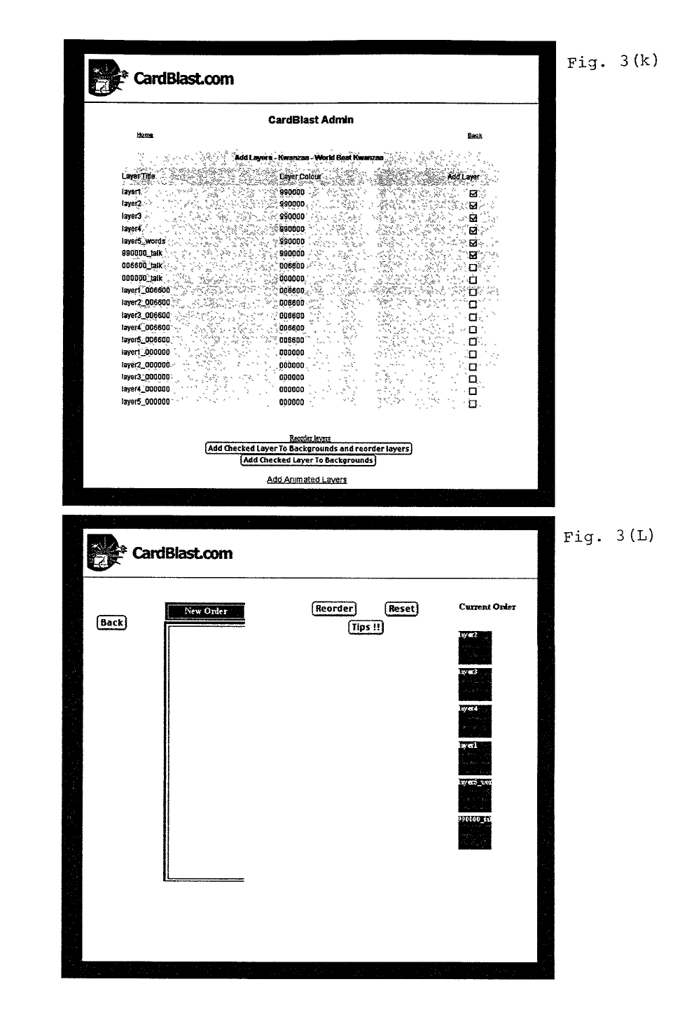

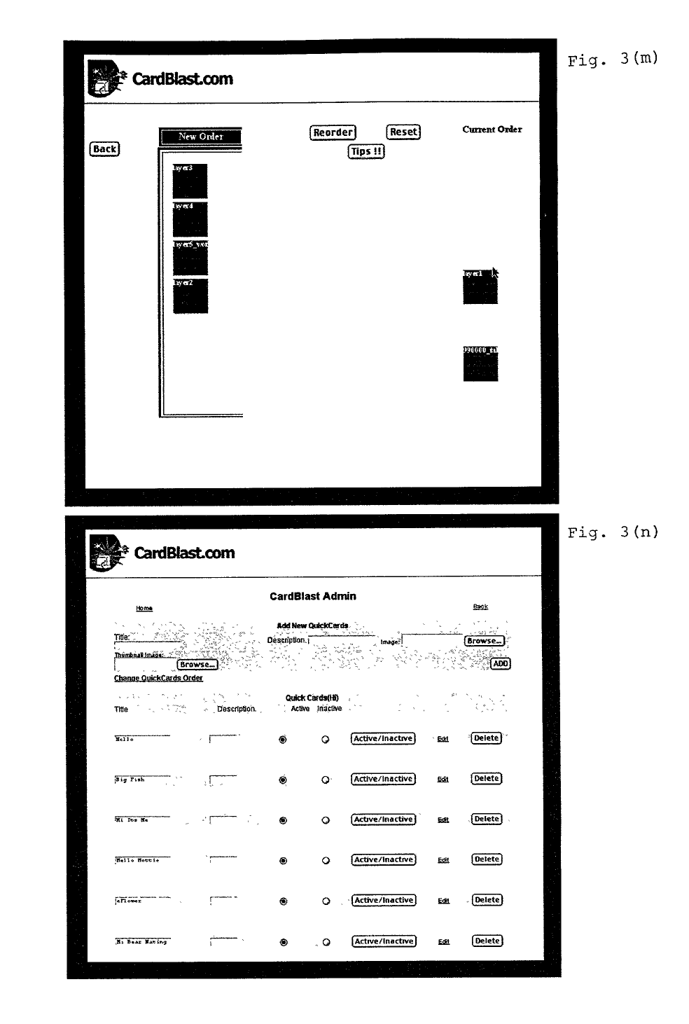

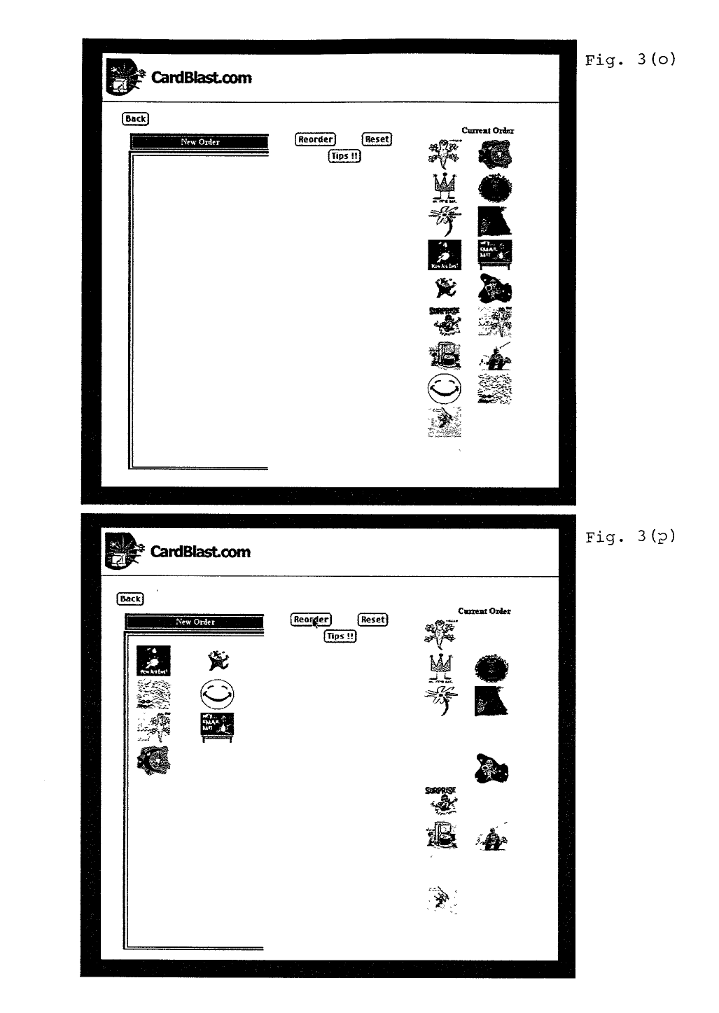

Examples of one embodiment of the steps to be executed by a typical site visitor or method user are shown in FIGS. 1(a) to (l). A user or visitor who determines to send only a QuickCard is required to execute only the minimal steps to send a card created with a few steps as illustrated in FIGS. 2(a) and (b) which describes one embodiment of the present method. The webmaster or site administrator views of the controls and status indicators for the server system which supports one embodiment of the present method are shown in FIGS. 3(a) to (j).

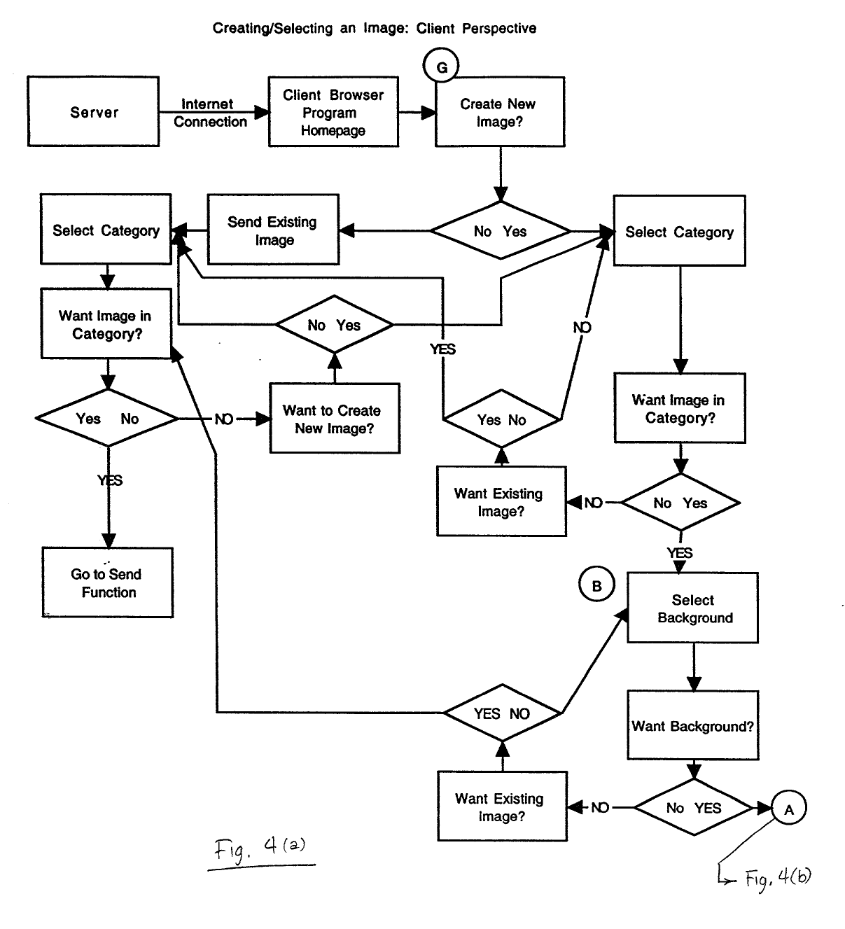

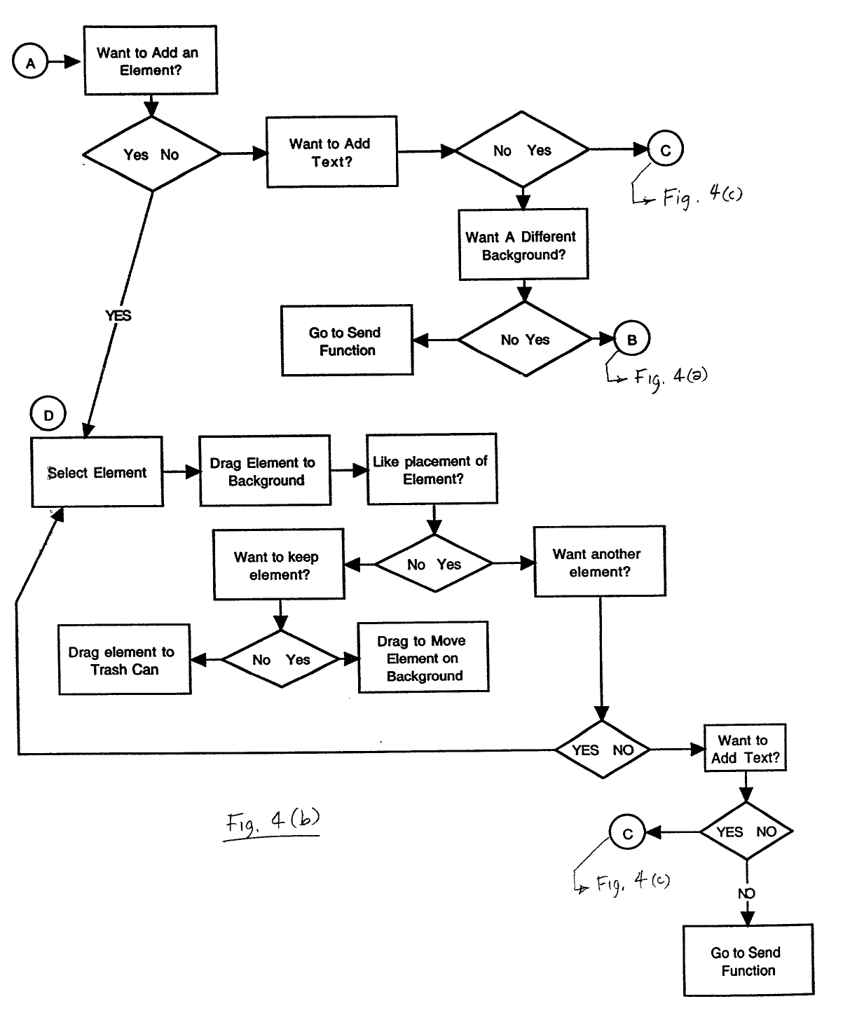

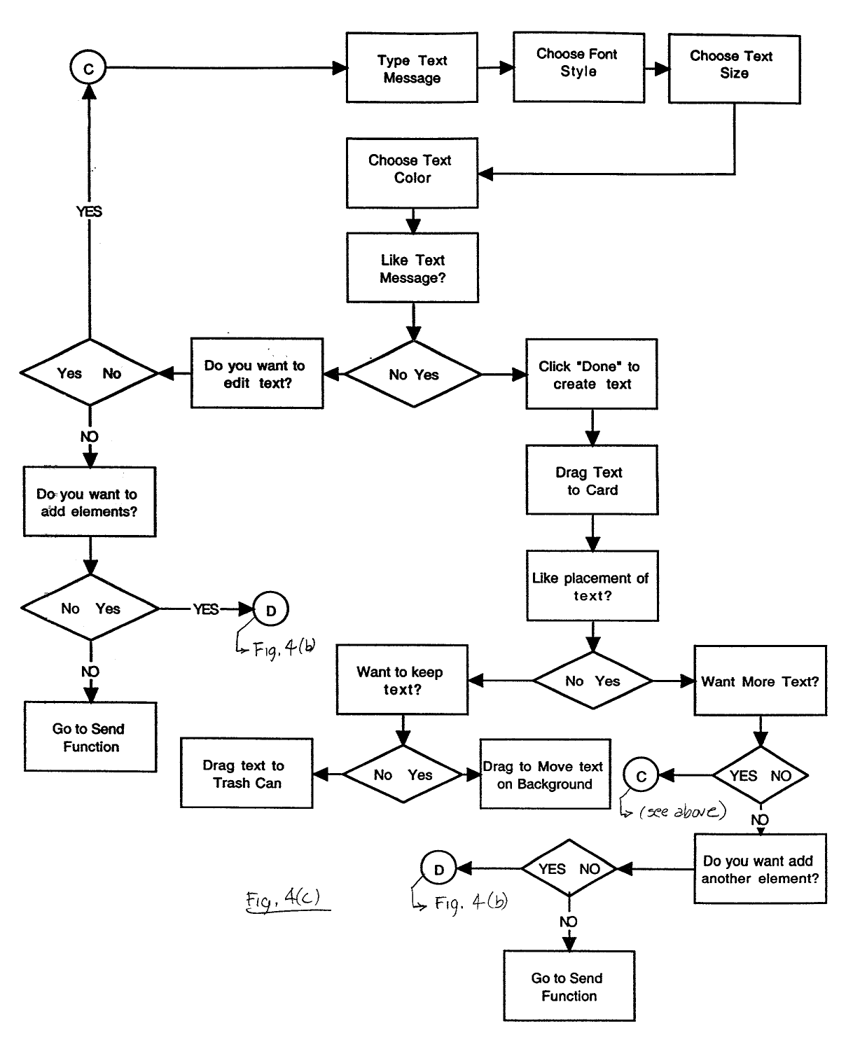

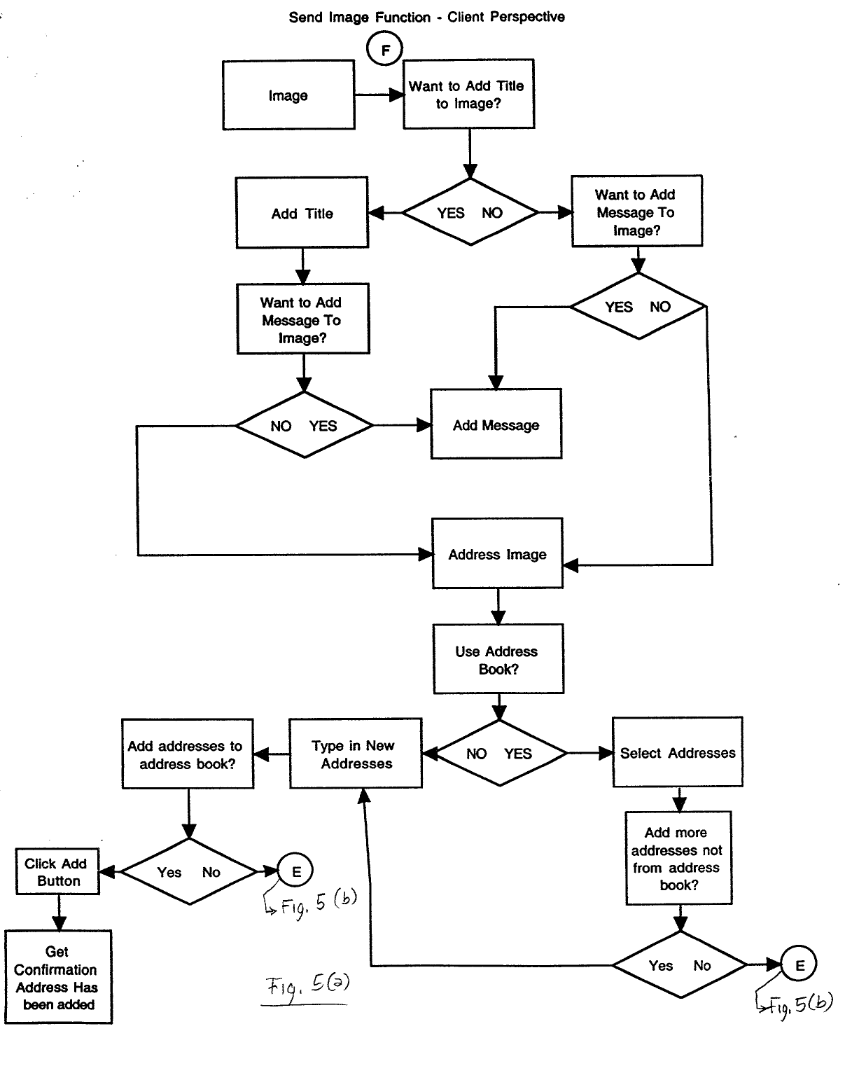

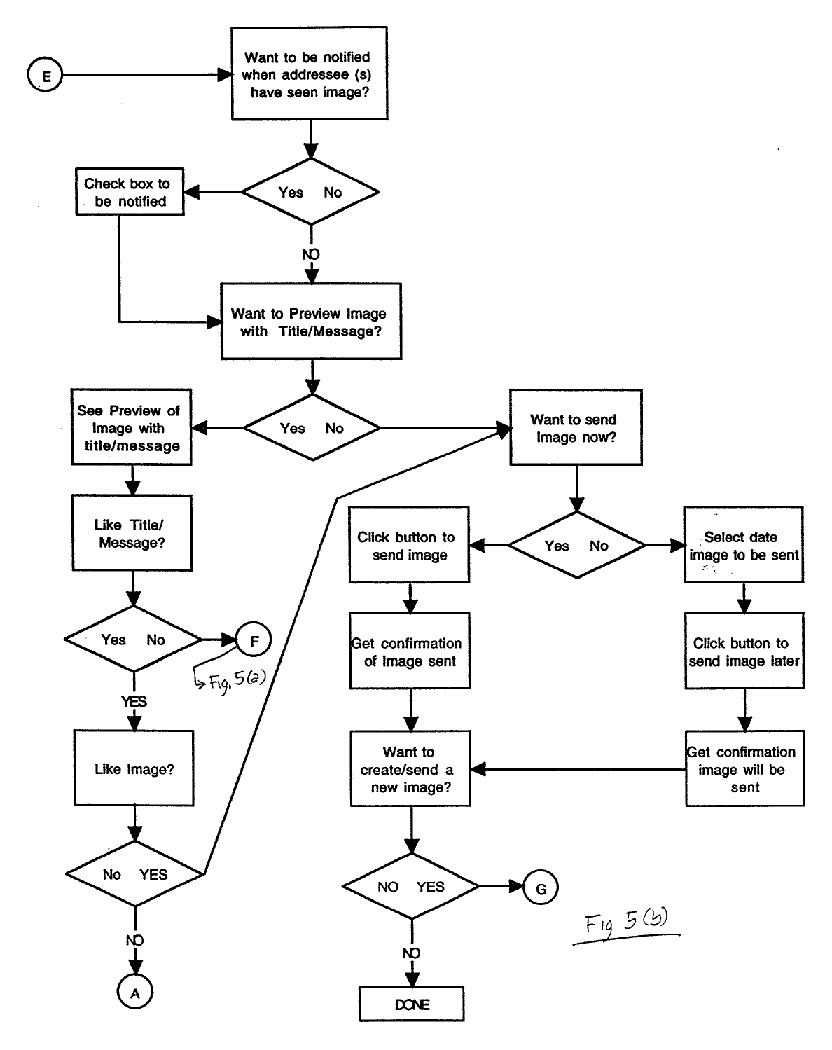

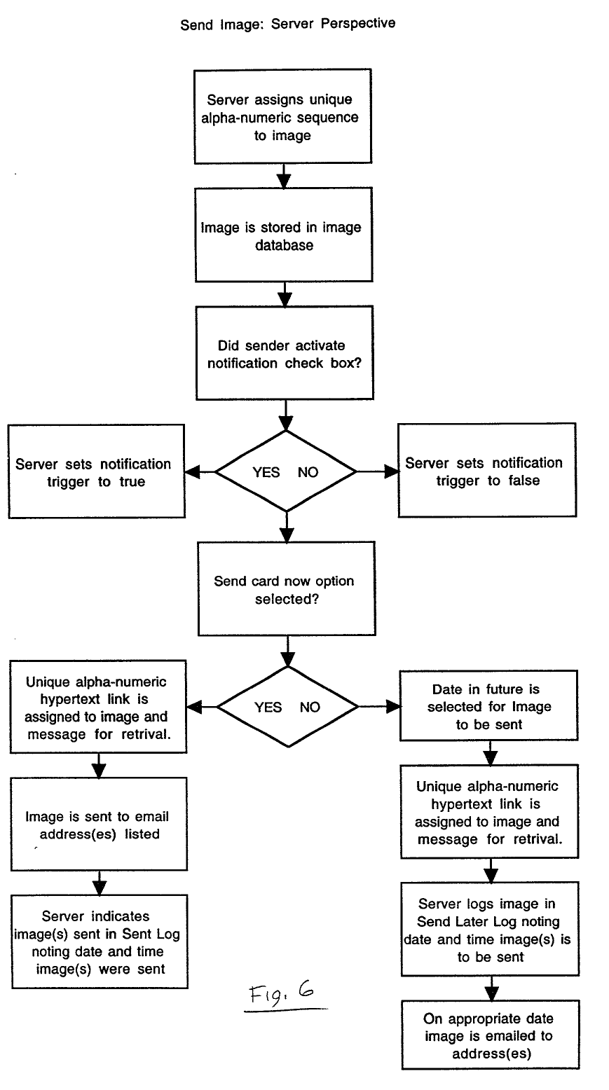

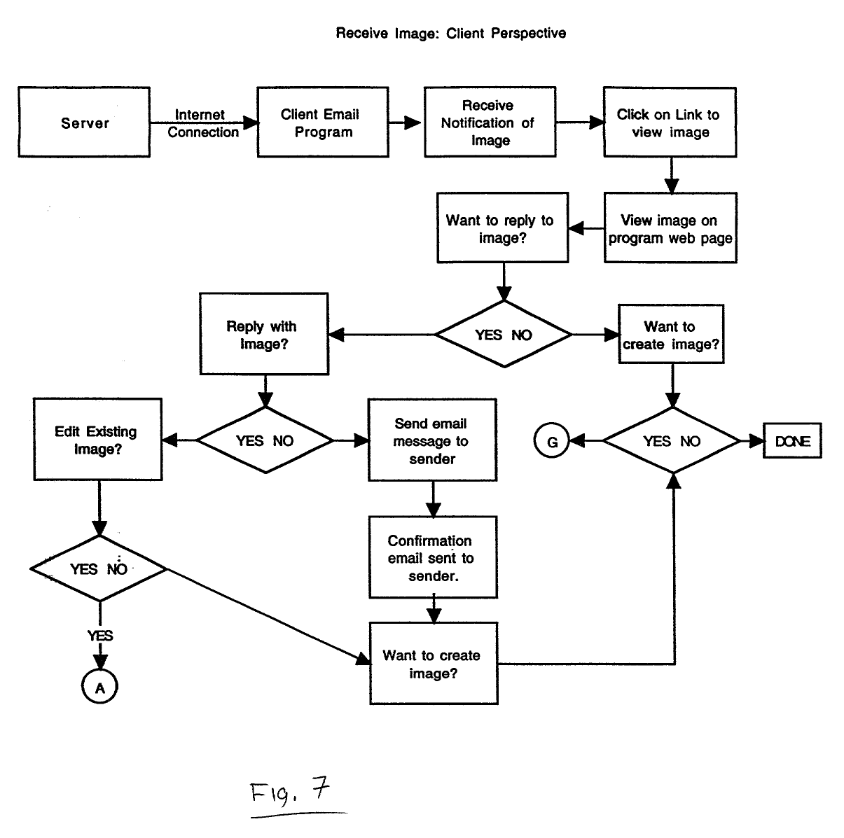

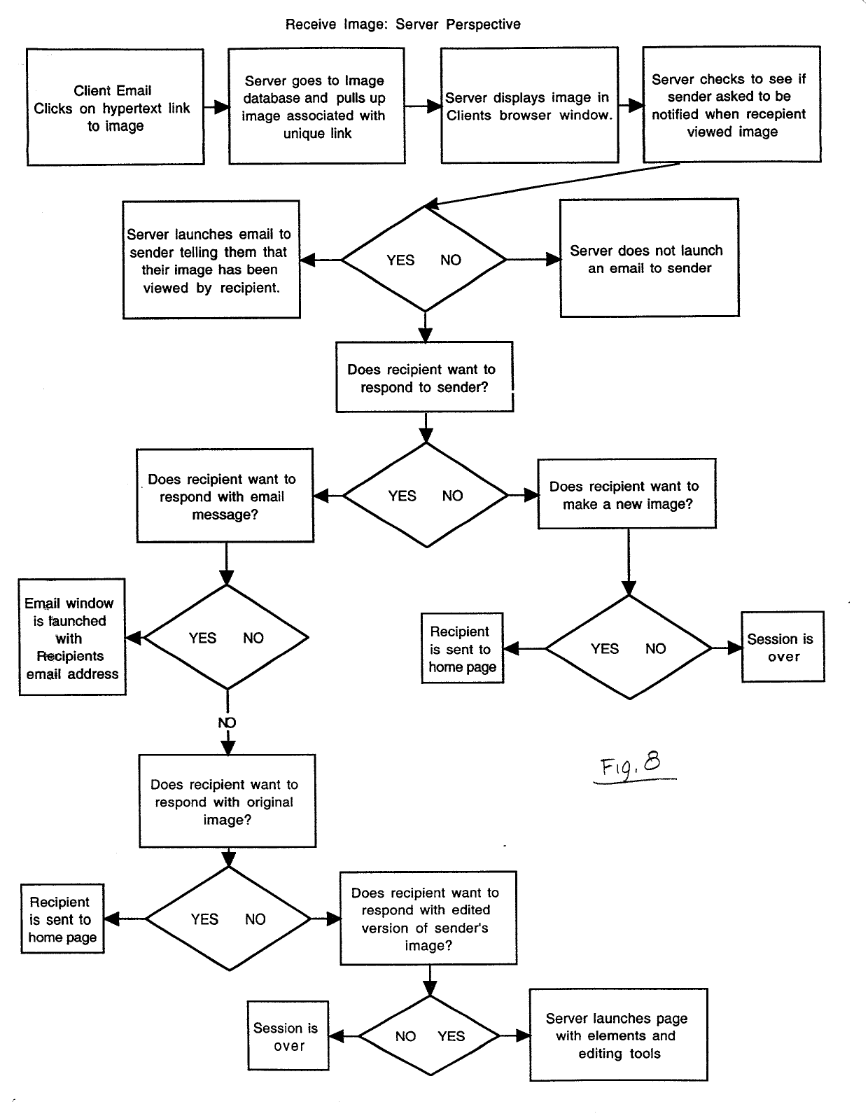

Generalized block diagrams of the flow of data and inputs for the present method are shown in FIGS. 4-8. These diagrams are, of course, diagrammatic and represent one embodiment, i.e., the CardBlast method.

4,2 User-friendly Image Selection- manipulation Methods.

The present system allows the user to select and move an object under feedback control into an image being developed. The feedback control is extremely valuable since it allows . placement of the new object with precise, visual control of separation or overlap with other objects already placed. The present system allows post-placement image editing including: x-y adjustment, scaling, rotation, and selected other graphic effects. In contrast, most simple message-image creation systems allow the user to select a graphic image from a small group of “thumbnails” and place it on the layout being constructed i.e., the target location is indicated by a pointing device and once-placed, no editing is possible.

4,2,1 The present system and method allows images to be constructed of multiple parts and placement of each component on a different layer. In this manner, the present system and method allows selection of layers and switching them between “on” and “off” display modes. This avoids frustrating, time-consuming frame or object selection when even a few elements are located within close proximity to each other.

4,2,2 The present system allows broad post-placement control of text fonts, colors, letter kerning, foreign symbols and other typographic effects Site-unique Perl algorithms are used to control layer development and visibility of text objects.

4,2,3 The present system allows on-the-fly creation of text notes which can be selectively placed on an image being edited. Similarly, the present system allows import of a document file or text block into a selected location in the image being constructed

4,2,4 The present system provides auto-save function so the user does not lose created images by the use of the “back” browser control. The present system provides temporary database files which define each element's placement on the selected background. The user's work for each session is uniquely identified and saved at the end of each session.

4,2,5 The present system allows immediate deletion of objects placed into the “trashcan”. To delete an element from the background, the user moves the selected object by DnD into the “trashcan”. When the element is released from DnD, it is immediately permanently deleted, i.e., it is not able to be recalled as is possible in certain operating systems.

4,2,6 The Java, JavaScript, Perl and other Common Gateway Interface (CGI) program code used in the present method provide users a characteristic “look and feel” of objects being manipulated on the screen which is largely independent of the specific user operating system, i.e., similar pointer functions/icons/displays whether the user's system is Apple, PC, OS2, Unix, or Linux even if the mouse for certain cases may have different numbers/arrangements of command buttons. Such uses of conventional user feedback as “mouse-over border” displays ensure that even a first-time visitor/new user will be immediately productive in assembling unique arrangements of elements in a new graphic creation.

4,3 Compact, site-unique code allows definition of user created graphic images, i.e., objects within objects and complex definition of object properties. Normally, such a process requires a massive, professional-type 3D wireframe, rendering or photo-editing program such as: SoftWorks (tm), Illustrator (tm), or PhotoShop (tm). Typically such complex graphic manipulation would be permitted only by the page designer or to the webmaster.

4,4 Compact, site-unique code to accomplish selected manipulation, under feedback control, of defined/selected objects, such as GUI, using Sun Java DnD subsystems or equivalent code. Normally this type of manipulation requires complex, large-scale code with critical hardware interface requirements (CPU, display, pointing device, etc.,.).

4,5 A site-unique database is used to track: every object selected (e.g., DragSource), each presumptive or explicit target-position zone (e.g., DropTargets) and every action (e.g., DragGesture) executed. Each user would generate a log of operations or records in this database for each creation. The site-unique management specify a default limit to each user database, i.e., size, precision, record limits and file retention/transfer/backup protocols.

4,6 Site-unique data transfer facilities and methods for selected platforms/protocols. Users or clients are allowed to upload a variety of files into a user-specific mini-database, i.e., file.txt, file.html, file.gif, file.jpg and internet-compatible audio and video files can be uploaded directly. Site-specific algorithms determine whether, which and the degree of file compression which may be applied automatically for each situation.

4,7 Site-unique browser ID, interfacing and data transfer protocols. When a user or client visits the site home page, the computer type, supplier and version of his browser is detected.

4,7,1 HTTP information Packets—Cookies.

So-called cookies, which are stored as a scalar variable, may be created by the CGI cookie function which includes the following arguments: name, value, expiration date, path, domain and security status. The user's browser must be enabled to transfer cookies which include user-specific data items. A cookie is set by the generating server into the user's browser and typical functions include control of colors, e.g., text or screen background. This aspect is significant since HTTP “cookies” potentiate the site-specific processes coupled to the “back” and “forward” navigation controls/buttons of the browser. The displayed screen is automatically refreshed to assure that the browser is currently displaying results of the most-recent user activity. Of course, persistent cookies being stored into the user's system must be guarded against refusal, deletion, corruption (or erroneously copied into an unknown or new directory path). For certain projects, it may be desirable to: transfer only cookies and to limit the transfer to specific servers/computers.

4,8 Site-unique future activity calendar-timer trigger/driver functions are provided to accomplish transmissions of notices/reminders at a predetermined future date/time. For example, the user may setup dates for future reminders to: (a) visit the site and create a new message or (b) confirm sending an already-stored message created earlier with a predetermined future send date. Alternatively, the user may enter requests to an input screen which instruct the site computer to send him reminders for the following options: (a) specific day of every week, (b) specific numeric-day of every month or (c) specific single day, i.e., month-day-year.

4,9 Site-unique history activity monitor for each user-session with summary displays and new action prompts (buttons, boxes, pull-downs, etc. with brief explanation) for each step involving an additional user decision between multiple options.

4,10 Site-unique, Action/Command-sensitive Help, Explanations, Examples.

As indicated above at 2,5, the website of the present invention includes a comprehensive online tutorial, help index and trouble-shooting guide. For the array of anticipated user errors, the site-unique system provides a an error notice or signal including prompt text for corrective/remedial actions. For embodiments of the present invention which require special/additional user input or user-history data to be exchanged, the system may be adapted to display a warning if the user's browser is set to reject such site-specific data packet exchanges or cookies.

4,11 User is provided with a site-unique repertoire of: user-selectable backgrounds, editable, primitive-type graphic objects, text objects, audio objects, video objects and provision for import or creation of user-unique images/text. The system and site-unique algorithms of the present invention can be used for a wide variety of artistic and professional purposes.

4,11,1 Production Planning, Storyboards.

Using the present system, a user may create audio or video storyboards for: editing/review with collaborators or markup/approval by the client. Typically, the generation project starts with the basic background portions or frames and some general text indication of the content and duration/extent of the activity/topic for each frame. Each team member would then receive the project file for input/comments. Each would then edit or amend the text, static graphics, video, animation and audio of frames he wished to change or perfect. During the early editing stages, one collaborator might, for example, upload a selected new video clip file, which was not available on the website, into a selected background frame. Another collaborator might subsequently edit this video clip by downloading it into his favorite video-editing program on his own workstation and then re-upload the new version back into the site-specific artistic-manipulation program where it can be displayed/played with an unaided browser. Throughout the entire joint creation process, which might include many stages and 50-100 element or background placements/adjustments, each text or graphic element is stored on its own layer and therefore able to be modified independently, i.e., sized, rotated, mirror-image reflected, or re-colored. Moreover, temporary text notes can be added as needed to stimulate new ideas and design improvements between collaborators.

4,11,2 Music CD Package, Cover, Text Notes.

The present system and site-unique algorithms also lend themselves effectively to collaborations between an artist/musician and a graphic designer. Together, they may select from stock backgrounds for selected topics already available on the website or one might upload a custom background. To this they might upload and attach a short, custom audio clip and other text/graphic elements to create the cover and notes.

4,12 Site-unique algorithms to allow user to select address-type data from the browser being used or other programs on the computer supporting the browser being used which store or maintain contact data for humans or electronic systems such as post, courier, pager, VOX FAX, email, networkURL, and others.

4,13 As permitted by the webmaster, designated users are allowed upload objects to the website for storage or display for specific time intervals/conditions. Selected users may be allowed to upload any/defined-range-of-types/specific-types of digital data including: line-art, continuous-tone graphics, animation, video, audio. Such site-interaction permissions can be for specific dates, time intervals, and for defined transfer processes. In this way, groups of users working on a large project can be allowed to make predetermined types of transfers and the webmaster may thus not access overload at critical times or swamping temporary memory resources. As explained elsewhere, each such uploaded custom file is represented by a distinguishable DnD icon to facilitate placement by users into a composite artistic image; since each is in a separate layer, editing by an unaided browser is rapid and user friendly.

4,14 By means of site-unique code and programs, webmaster has full control, i.e., change, delete or expand, the repertoire of all unique images stored and presented to selected classes of website users as well as their titles, topic indexing, topical linking facilities and their presentation sequence/groupings.

4,15 By means of site-unique code and programs, webmaster has full control of the repertoire of typographic controls available at selected times to each class of users.

4,16 By means of site-unique code and programs, webmaster has full control of the repertoire of user-created images/messages/transfer requests stored in databases linked to website

4,17 By means of site-unique code and programs, webmaster is able to use high-level parametric methods to revise or update the unique “look and feel” of all user controls (buttons, list boxes, pull-downs, etc.,.) presented and implemented on the present image-generation site as might be dictated by availability of new code or hardware technology, changing climatic seasons, current economic or political events, etc.

4,17,1 Site-unique Display—Arrays of Backgrounds and Elements.

One greeting-card embodiment of the system of the present invention includes the following steps: choose a card category, choose a background, choose and position images on the background and send the newly-created card by email at a defined time. The user is guided through these steps by a sequence of screens displaying choices and action buttons. It is envisioned that certain visual features including the style of the guide pages, their sequence, the item complexity and the placement of items to be selected or DnD manipulated will be adapted according to additional specific requirements or completely new purposes. It is further envisioned that parametric modeling will be used in the preparation of the website display pages for ease of conversion and adaptation of the object-layering technics of the present invention. Such display-adaptation methods include: auto-scaling of a group of backgrounds/elements, changing of the shapes of groups of selectable zones with a single command or automatic edge-alignment/boundary-spacing of a group of selectable zones with a single command.

4,18 Preferred Embodiment

The method and system of the present invention can be customized to accomplish many different and divers functions. The present method and system may be embodied and to operate on any known computer system which permits internet connection and access by available unaided browsers. A number of alternative embodiments of the method and systems are disclosed in the Examples section below. The general and particular characteristics of one embodiment, i.e., the CardBlast card-generation website are shown in FIGS. 1-8 above. the most important characteristic of this embodiment is that complex and sophisticated graphic manipulations can be accomplished by an unaided browser using the present method and systems, i.e., no plug-in program, with associated interface and functional problems, is required.

4,18,1 Method and Site-system Embodiments

The method of the present method is inherent in a system of coordinated, site-resident, unique dynamic code algorithms mounted on the site server(s) which enable user-friendly browser inputs, i.e., by means of keyboard and/or pointing devices, to initiate and control creation of graphics and text by any site visitor. The significant novelty and unobviousness of the present server system, unique algorithms and related use data-graphics use method is that no browser “plug-in” programs are needed. This functional aspect is a distinct benefit both to users and to site managers since:

(a) typical browser “plug-ins” are provided as “free downloads” of “buggy”, bulky and frequently inefficient program code developed by unrelated third-party firms which is called by the browser whenever a site is marked for its use,

(b) typical “plug-ins” are slow in operation,

(c) browser “plug-ins” are sometimes modified or updated upon computer startup by automatic procedures not controlled by the computer user —these uncontrolled processes may load and activate versions which are not compatible with either the user's browser or code on a site which “calls” the “plug-in”, and

(d) “plug-ins” sometimes cause the browser or the entire operating system to “crash” because of profound code conflicts.

A site visitor may become a registered user by providing keyboard and selection inputs, i.e., radio buttons or pull-down menu “picks” to a site-generated screen display containing blank data fields including but not limited to: user name, job name and related secure ID codes or “passwords” for each.

During a predetermined time period after the initiation-creation stage for each job (for example a period ranging from 4 weeks to not-limited), a registered user may make additional browser visits for a variety of purposes including but not limited to: printing, viewing, modification, revision, file uploading, renaming, deletion or electronic/digital distribution, i.e., email, FAX or graphic file such as Acrobat(tm). It is envisioned that one or more spatially-remote individuals, by sharing a see job ID code, would access an ongoing job at different times to add inputs of one type or another during the collaboration or negotiation.

It is further envisioned that all or any portion of a job display prepared by one user can be “locked” relative to the site memory but able to be viewed, copied, revised, printed, emailed or saved-controlled as a different new job by a new individual with only visitor status. This would allow a visitor a wide variety of creative choices whereby selected site-presented elements and unique inputs might be combined and arranged into desired configuration(s) and stored for later review or transmitted by a variety of electronic or optical means to a designated recipient immediately upon completion. It is further envisioned that this method of use would offer the additional possibility of initiating and executing a wide variety of commercial and professional transactions or data exchanges, e.g., custom constructed-assembled apparel components by use of specific anthropomorphic dimensions, colors, fabrics and other artistic details or secure web-submission of medical history data.

The use method for generation of an email communication can be illustrated in the following sequence which generates and transmits a greeting card:

Step 1. The site display begins with FIG. 1(a). The visitor can select any text or graphic item where the browser pointer changes into the link symbol (a gloved hand); by convention, these link areas are indicated here as graphic frames or underlined text strings.

Step 2. FIG. 1(b) illustrates the result of one pointer click to the page portion which displays themes such as Holidays and Occasions.

Step 3. FIG. 1(c) illustrates selectable options for graphic frames and backgrounds.

Step 4. FIG. 1(d) illustrates the next step once the checker-board frame background of the previous step is selected. This step is to drag-and-drop one of the pictures displayed in the right panel for the preferred top-line or “tool-bar” selection (the default pictures as shown, more pictures, animations, make words) into the selected frame. The placement is accomplished by holding the pointer button down during dragging from one position into another. If the visitor is satisfied, the card can be sent by clicking on the send button. If the visitor is not satisfied, there are several remedial choices provided: (a) select one or more background-placed items and drop them into the waste basket, (b) back up and choose another background and (c) cancel both background

Step 5. FIG. 1(e) illustrates the screen display to facilitate keyboard entry and font size-color formatting of a unique text string entered into the upper frame when the “I-beam” symbol appears. This is the conventional visual signal to the user that text may be entered; it appears after clicking in the area with the pointer.

Step 6. FIG. 1(f) shows a following text styling frame; the right panel of this frame allows disposal of separate words. As Step 4. above, the user then has several push-button options: send, trash, get new background, get new card.

Step 7. FIG. 1(g) shows the method of dragging a selected animal image into the background with the word “EH” already placed and styled (color and size).

Step 8. FIG. 1(h) shows the addition of symbols and text images from a previously collected or generated subgroup called “MY WORDS”. Many options as above are possible for sending or further revision.

Step 9. FIG. 1(i) displays still more options for the sender to: update/add new names to recipient address list, include a gift with the card resulting from the previous stage, defer transmission of the card(s) and email delivery confirmation.

Step 10. FIG. 1(j) shows an added message from the previous step and four additional options: send email, send quick thanks, send this card and print.

Step 11. FIG. 1(k) shows the display screen with fields for key entry of desired send-date, and three additional buttons OK, make new card and return-to-home-page.

Step 12. FIG. 1(l) shows the automatic “sent” confirmation showing the addressee name (“Wendy”) and provides options to send a gift or another card.

The use method for a pre-made greeting card can be illustrated in the following sequence which quickly and easily generates and transmits a stock-type greeting card:

Step 1. FIG. 2(a) shows the initial screen display and thumbnail depictions of 12 different images and a proposed text message. The visitor simply points to a selection to complete this phase.

Step 2. FIG. 2(b) shows the final step and the group of typical options including: add a message, add a title, audition/select/add audio music file, add names/email addresses to address book, confirm receipt by email, send now, send later and make changes.

The webmaster's view of the contact-site shows the regular maintenance and “housekeeping” procedures of the main and subprograms along with a list of the site zones and related functions and files.

FIG. 3(a) shows management options for site-unique algorithms and the files they use across three major management-activity zones: drag-and-drop, pre-made and Expert.

FIGS. 3(b) to 3(e) illustrate some usual maintenance options for several file-type items in the drag-and-drop zone shown in FIG. 3(a) above.

FIGS. 3(f) to 3(h) show graphic maintenance options pertaining to ordering of images among positions, and placement of an icon image.

FIGS. 3(i) to 3(m) show background maintenance ordering options and related layer colors.

FIGS. 3(n) to 3(p) show some usual maintenance options for pre-made or stock-type cards

At the choice of the site managers and webmaster, certain visitors desiring to become registered members might also be required to provide information for billing of selected standard or optional services which might be selected for a chosen job; for example, such billings might include extension of the time interval for maintaining-storing the job file in active status for instant editing by users. Similarly, site managers might also require other specific, private or economic information about users or their demographic data.

The present method is able to be practiced by networked users with only a browser because of the coordinated functions of a system of code applets integrated within the site program code which allow a user to input dynamic drag-and-drop interactions and thereby make rapid creative selections from a repertoire and subsequent changes to any selected images within a chosen job file.

It is further envisioned that users may be grouped by certain additional ID data and that specific groups of site functions might be available to one or more designated user groups. These group-enabled functions might include, but not be limited to: (a) subgroups of repertoire items including images, screen key-input forms, text strings, etc., (b) higher browser-command execution priority under times of heavy site traffic and (c) special access security measures and/or special operations-procedures of file encryption for internet transfer.

4,19 Illustrative Application-Examples of the Method and System. Several examples are shown below to illustrate a few of the many professional, retail, and artistic purposes to which the methods and system of the present invention may be applied. Generally, each example employs an internet website which interacts with a the user's “stock” or unaided browser to permit rapid, user-friendly, creating of unique composite images based upon combination of an array of predefined, displayed types and the additional possibility for the user to upload files for “customized” images. As has been disclosed, the coded programs employed on the site provide for each image to be stored in its own level so that it can easily be independently manipulated. Finally the methods and process provide for the possibilities of storing, delivering, displaying and continuing modification/collaboration to prepare and refine images. While the examples below cover a few applications already being developed, the present methods may easily be used to combine all known static and dynamic artistic effects including animation, dynamic photo-image morphing, audio, video, acoustic/ultrasonic/mechanical vibration, etc.

4,19,1 Greeting Card Creation

A user starts his computer, internet browser and goes to the greeting-card site; there he selects a category (Holiday, Occasion, Sentiment, etc.). After selecting a category, the user then selects a background from a selection of backgrounds. At the site, the user may also upload a picture/graphic image from his own computer to serve as a background. Once a background is selected, the user may proceed to a page or screen where there are arrays of predetermined related graphic elements to DnD (drag and drop) on to the selected background. Again, a user might upload photograph or an image to serve as element(s).

On this screen display, the background and elements are shown along with a button that gives the user the ability to create text, which is dynamically turned into an element Each element is on its own layer and can be modified independently of other elements. For example, if a user were creating a Birthday card, the user might select a background with images of candles on it. Then, the user would go to the elements screen. There would be any number of elements a user could choose from to create the card by DnDing (dragging and dropping) the element on the card. Since each element is on it's own layer and can be modified independently, a user can DnD an image of birthday cake and make the displayed element bigger, smaller, rotated, flipped horizontal or vertical, re-colored etc., as desired. Then a user might DnD an image of a candle and make the displayed element bigger, smaller, rotated, flipped horizontal or vertical, re-colored etc., if necessary. The user could also create text (like “Happy Birthday”) and drag and drop that text onto the card. The DnDed text may then be made bigger, smaller, rotated, flipped horizontal or vertical, re-colored etc. if desired.

Each time a user DnDs an element or text onto the background, a new layer is dynamically generated and placed on top of the stack. If a user selects an element on a lower layer, that element is made “active” and may be modified.

Once a user decides the greeting card is complete, the user may send the greeting card to a single recipient or multiple recipients be either typing in an email address or accessing the selection of email addresses from a built-in address book, e.g., the address book of the browser. A user may also select to be notified when the recipient(s) has viewed the card. Additionally, a user may select to send the greeting card now or at a designated time in the future.

4,19,2. Technical Illustrations and Architectural Drawings/Design

A user can create and collaborate on technical drawings/manuals/appliance/kitchen designs using the method of the present invention. Once at the site, a user may upload one or more images for a background and/or as a major new or altered element, thereby to modify the drawing/design as originally displayed.

For example, if a user is collaborating on designing an industrial oven, the user may upload a base image to serve as a background and additional images to serve as elements (.e.g., knobs, handles, logos, etc.). A user may the DrD one or more of the uploaded elements on to the background to create a changed version of the oven. A user may also create text to put on the image. For example, a new text note pointing to a handle that might say, “cast aluminum” to identify the material or production process or other additive text.

Since each original or added element is on its own layer it may be modified independently, any element (knob, handle, etc.) may be scaled, rotated, flipped horizontal or vertical, re-colored, etc.

Once the industrial oven is designed, the user may send the modified image via email to a co-collaborator or co-collaborators. Once the image is received by the co-collaborator(s), the co-collaborator(s) may modify the image by DnDing new elements on to the design, removing or deleting previous elements from the design, adding text notes and modifying selected aspects of any selected element (knob, handle, etc.) by scaling, rotating, or flipping, etc.

This modified version of the image may then be sent back via email to the original user or other co-collaborators for further modification.

The same general method could be used to collaborate on architectural or bathroom/kitchen/pool/spa designs, using -standard-type architectural images/symbols as elements. It is further envisioned that collections of standard and customized symbol elements will be available to one or more collaborators in the form of files or downloads from the internet sites.

4,19,3 Gift Certificate

A user may create an electronic gift certificate using this system. A user goes to the site and selects a gift-certificate category (for example, birthday, Father's day, love, etc.). Within the selected category, a user may either: (a) select a background from the array presented or (b) upload an image from his own computer to serve as a background.

Once a background is selected, the user may define one or more elements which may be DnDed onto this background. Each one of these images is then linked to a database which provides current retail data on the selected merchandise, item or service.

For example, say a user wants to create a gift certificate for his Mother on Mother's day. At the site he might go to the Mother's Day category then pick one of the backgrounds displayed. With the background is chosen, he would then proceed to a screen with a display of related elements which may be DnDed into that background. For this case, the element icons represent gifts a user could purchase for his Mother, which the Mother may redeem at a specific geographic outlet or “online” internet store. Should the user choose a book, the user would DnD an image of the book, or representative icon, on to the background. The user may also create a text message and then DnD it to the background. Since each element, including text, is on it's own layer for the customer's site display, it may be modified independently, thus any element selected may be scaled, rotated, flipped horizontal or vertical, re-colored, etc. to achieve a unique, tasteful gift certificate.

The user may then send the gift certificate the same day to his Mother via email or other delivery means. The user might alternatively select to send the gift certificate instantly or at some designated time in the future. The user may also express his preference to be notified by email or other means when the gift certificate is received.

For the case of an emailed gift certificate, the Mother may click on the image of the book and be taken directly to the online site to redeem her book(s) and to define delivery times/methods of the actual item(s).

4,19,4. Landscape/Interior Design

A user may create/design/modify landscapes and interior designs using the system and methods of the present invention.

A user may select from a preexisting background image or upload his own image from his computer to serve as a background. Once a background is selected, a user then goes to a screen in which the background is shown with elements (either preexisting displayed images or images the user has uploaded from his own computer) which may be DnDed onto the background to create a unique landscape or interior design. The graphic images of the resulting unique design may then be transferred using various electronic means including file transfer, email attachments, etc. to other colleagues/collaborators/designers/interested parties who may further modify the design and send it either: (a) back to the original user or (o) send it to others.

For example, a user wants to buy new furniture but isn't sure how it would it look in his existing living room. A user would upload a picture of his current living room to serve as the background. Then, the background would be shown with several furniture/design elements, such as couches, chairs, carpet, rugs, tables, etc. which may be DnDed onto the background. Since each element is on it's own layer and may be modified independently, a user may DnD a image of a couch and make the image bigger, smaller, rotated, flipped horizontal or vertical, re-colored, etc. Then the user may select another element, such as a chair, and modify the element by scaling, rotating, flipping or re-coloring that element. A user may continue to add elements, remove elements and modify elements until the desired appearance and symmetry is achieved. A user may then add text to describe or highlight the images. For example, the text might read, “this couch may be covered in brown leather or brown tapestry”. Once the image is complete, the user may either: (a) purchase the pieces of furniture selected, if the site is a commerce site, or he may send the image to an interested party.

Typically the user may send the image via email to one or more recipients. Once the image is received, the recipient(s) may modify the existing image by removing/deleting elements, e.g., items/arrangements/ensembles of furniture, adding elements or modifying elements by scaling, rotating, flipping or re-coloring one or more selected elements. The recipient may also add text messages to the image in response to the sender's note/query text (for example, “use the brown leather”) or he might create new text for comments/responses. The image may then be sent back, via email, to the original sender or to other interested parties.

The same methods and processes be may also applied to landscape design using yards as backgrounds and plants/shrubs/flowers/trees/outdoor furniture as elements.

4,19,5. Graphic Design Layouts

This system and methods of the present invention may also be used to create and collaborate on a wide range of graphic-design layouts, including, feature/price/warranty labels, marketing brochures, information leaflets, letterhead, business cards, storyboards, etc.

A user may upload an image to serve as a background or choose from a selection of predetermined backgrounds. Once the background is chosen, the user then goes to a screen or page where the selected background is associated in a display with several elements (either predetermined or uploaded from the user's computer) which may be DnDed to create a pleasing, business or professional image.

The methods and processes of the present invention are used according to the following example. A graphic designer assigned to create an advertisement layout for a client might first visit the ad-creation website and select and/or upload a suitable background(s). Then, select and DnD onto the background from a repertoire of screen elements thereby creating a unique new image. In this example, the designer might upload the characteristic or repeated items such as client's logo, product-specific photos and/or eye-catching line-art illustrations and other distinctive artistic features identified with the specific client, products or medium to be used. The resulting storyboard, design or layout may be transferred or exchanged by email between colleagues at the firm(s) directly involved or to other outside consultants involved in the decision-making processes. Interactions such as described above may thus be continued until the project is completed and accepted by the owner or client.

4,19,6 Games

The system and method of the present invention can be used to enable and facilitate game-playing online in one or more modes: (a) a solitaire-type game wherein the user plays by himself or herself, i.e., the user plays against a program algorithm contained within the computer or (b) a group-type game wherein the user plays against multiple players linked simultaneously or sequentially across the internet.

To start, a user goes to the site and selects a game from the multiple choices displayed. The start-up display may also show which games are real-time/simultaneous and which ones are off-line/sequential only. Once a specific game is selected, the user then goes to the page or screen where the selected game board appears as the background and elements or appropriate array(s) of game pieces is/are displayed. At the start stage, the pieces may be: (a) already positioned on the background, or (b) in a holding area and available to DnD about onto the background or game path at the proper starting point.

For example, the user might elect to play “online” versions of chess, Monopoly (tm) or Scrabble (tm). The methods of the present invention may be applied equally well to games which utilize: a predefined board-position array or a travel path -if consisting of multiple steps and moveable markers for each player, or those wherein the elements being played define the instantaneous layout such as dominoes or Scrabble. The user can select either to play against the computer or to play against another user or users by emailing the board back and forth between players or teams.

In a chess game, Player-1 would DnD a chess piece, i.e., move a pawn into a new location on the background or game board. If the user were a player against a computer with a chess algorithm, the program and display would respond immediately with a retort move. If the user were playing against another player, Player-1 would, after each move email the game board to Player-2. Upon receipt, Player-2 would then move responsively by DnD an appropriate chess piece into a new position on the game board and return it back to Player-i . Play would continue in this way until one of the Players got checkmate.

Many games can be played in this DnD fashion: Scrabble (tm), puzzles, e.g., Jenga (tm), Mastermind (tm); many games of skill and/or chance can be adapted—modified for play by the system and methods of the present invention.

4,19,7 Educational Concepts/Learning Tools

This systems and methods of the present invention can be used as an educational tool, i.e., to help teach basic or complex concepts. The resulting methods are adaptable for children or adults for teaching a wide variety of skills and mental concepts; further it is envisioned that the methods can be implemented to help anyone who may be perception disadvantaged or learning challenged.

For early learning, e.g., grade-school children, this system can teach core educational concepts. A child can learn basic skills, e.g., matching, grouping, number concepts, language arts, etc. For example, a child can DnD all the items beginning with the letter A onto a background. Alternatively, a child may create on “online” book by using graphic elements to illustrate selected text Since each element is on its own layer and can be modified independently, a user may DnD a image for a story and make the representation larger, smaller, rotated, flipped horizontally or vertically, re-colored, as might be desired. Students may also upload images they have created in other computer programs for use in or modification of their “online” books and may also send their work, via email, to a teacher or another person for corrections, input, etc.

For more advanced students, the present system can be used to teach more complex concepts, like science, engineering, design, etc. For example, a more advanced student might learn how to build a better mousetrap by DnDing 2D or 3D building elements onto a background to see how they fit and work together. Since each element is on its own layer and can be modified independently, a user can DnD an array of building elements for a archetype mousetrap and make it bigger, smaller, rotated, flipped horizontal or vertical, re-colored etc. if necessary. Then, by animating the allowed movements and interactions of the elements, a student may illustrate how the “improved” mousetrap would work or detect design oversights. Students would be able to collaborate with others by sending their mousetrap, via email, to another if person, who might then further modify the design. A recipient might send the modified design back to the original sender or to another collaborator.

Many educational processes and technics would benefit from the present system.

4,19,8 Consumer Goods

This system and methods of the present invention may also be used to design clothing outfits, entertainment systems, gift baskets, etc.

For example, if a user wants to create an ensemble with coordinated colors, shapes, textures, he or she might visit the site, select on an appropriate background-mannequin from the array presented or upload an image, perhaps a photo of him or herself to serve as a background. Then, the user would be taken to a screen with the selected background along with an associated or harmonizing set of elements. The user would then DnD these elements onto the background. Since each element is on its own layer and can be modified independently, a user can DnD a shirt onto the background and make the shirt larger, smaller, rotated, flipped horizontally or vertically, re-colored, etc. The user might further also add text, e.g.,“I am a size 2.”, to the image, which is on its own layer and can likewise be modified independently. The user may then continue to add elements until the image is complete.

When the image is complete, a user might: (a) opt to purchase the outfit—if it is linked to an electronic commerce site or (b) or email the image to a friend who might want to purchase the items for her (see 4,19,3 Gift Certificates). Alternatively, the user might email the image to a person/persons who might require prior approval/right to modify the image, e.g., a formal ensemble for an important occasion. In like manner, the user might send it to the person who is going to wear the outfit or to a person who will give a second opinion).

Once the image is received, the recipient(s) may modify the existing image by removing elements, e.g., items of clothing, adding new elements or modifying original elements by scaling, rotating, flipping or re-coloring the received array of elements. The recipient may also add text messages to the image in response to the sender's text, e.g., “You wish you were a size 2!”. The recipient would be permitted to create any new text. The amended image with possible text notes/additions can then be sent back, via email, to the original sender or to other interested parties.

The same methods may easily be applied to entertainment systems using electronics as elements or gift baskets, using gift items as elements. Users can also create an electronic “registry” for weddings, new babies, etc. using items they would like others to purchase for them (see 4,19,3 Gift Certificates).

4,19,9 Invitations

The system and methods of the present invention may be used to create and exchange electronic invitations and responsive confirmations. The user goes to the site and selects a category, e.g., Holiday, Occasion, Sentiment, etc. After selecting a category, the user then selects a background from a displayed group of backgrounds. In case no suitable background is displayed, a user may, if desired, upload a photo image or line-art graphic from another source or file to serve as a background. Once a background is selected, the user then goes to a page or screen which includes a predetermined array of elements which may be positioned upon the background by DnD modes. At this stage also, a user is permitted to upload an image file to provide new or unique element(s) for DnD placement(s).

For example, if a user were creating an invitation to a Birthday party, the user might select a background with images of candles on it. Then, the user would go to the elements screen which presents an array of elements and choose one or more from the group to create the card using DnD modes. Since each element is on its own layer and can be modified independently, a user can DnD an image of birthday cake and make the picture bigger, smaller, rotated, flipped horizontally or vertically, re- colored as might be desired. Then a user might also DnD an image of a candle and further modify it by size scaling, rotation, flipping horizontally or vertically, re-coloring. Likewise every element can be positioned and modified to the user's taste. The user could also create new text such as “Come to our potluck” or request that each person: (a) bring a specific item to the party (b) respond to RSVP before a certain time. Next he might DnD the text onto the card. The text can then be made larger, smaller, rotated, flipped horizontally or vertically, re-colored, etc. as might be desired or necessary.

Each time a user DnDs an element or text onto the background, a new layer is dynamically generated and placed on top of the stack. If a user selects an element on a lower stack layer, that element is made “active” and can then be modified.

Once a user decides the invitation is complete, the user can send the invitation to a single recipient or multiple recipients be either typing in an email address or accessing addresses from a built in address book A user can also select to be notified when the recipient(s) has viewed the card. A user can select to send the invitation now or a designated time in the future. Once received, the recipient(s) may modify the invitation and send it back; in this way the modified-returned invitation becomes an RSVP to the party.

1. A method for using at least a pair of computers interconnected by means of one or more networks and each provided with a typical internet browser, a color-display screen and input devices including at least a pointing device and a keyboard, whereby information exchange is facilitated between them utilizing a remote, contactable website, the method comprising:
(A) said first individual inputting into first computer parameters sufficient to achieve a workable network connection to said contactable website;
(B) after establishment of a workable network interconnection, first said individual further providing inputs into first computer consisting of:
(1.) a job identifier and password for a previously-stored, still-active-status and website-stored job file containing all prior work on said job, said identifier being associated with the password-secured job file as most-recently modified, or
(2.) keyboard or pointer responses to predetermined input data- or selection-field prompts displayed by said remote site i. sufficient to initiate, create and password-save an identified new job;
(C) first said individual further inputting into first computer inputs sufficient to produce one or more changes of said identified job file selected from:
(1.) original-input graphic or text elements, (2.) additional site-displayed graphic or site-displayed text files, (3.) additional executable program files capable of modifying any existing elements, (4.) reformatting, correcting or rewording of a text element and (5.) modifying color, appearance, position, spatial arrangement or form of a graphic element, using customized graphic and text tools provided at said contact site;
(D) first said individual further inputting into the computer command parameters to cause the site system to save said resulting job file in a designated portion of site memory and exiting from said remote site;
E) at a subsequent point in time and during said active-interval for said job file,
(1.) said first individual communicates sufficient “password” data to said second user that latter may access said stored job on a computer,
(2.) second said individual further inputting into second computer said “password” and sufficient other selection parameters to cause said site to display said job file and permit a full range of creative actions including but not limited to editing, printing, emailing,
(3.) said second individual further inputting text, options, elections and selections as desired to interact with said job file,
(4.) upon completion of said interaction steps, said second individual providing computer inputs sufficient to cause said site system to save changed job file in a designated portion of site memory and upon completion of the save, exiting from said remote site; whereupon subsequently said first, second or both or other designated individuals may continue to interact repeatedly and sequentially with said job file using said computers and said contactable site.

2. An online system for creating and exchanging electronic images-messages, including an internet-connectable remote computer system provided with a website system for online interactive image-message creation and communication-message exchange between users of said website, said website system comprising:
(a) a server comprising at least a digital memory store with connected processor and having graphic-management programs removably rigged therein,
(b) a user-friendly online screen-prompt environment which facilitates user's access to an array of manipulation tools and an array of predetermined graphic resources, said tools and resources engageable by a keyboard and/or known pointing device for creating images and sending electronic messages containing images and other data formats, said resources including one or more topical image categories, each said category including at least one displaceable background graphic, one or more displaceable main graphic elements and other linkable files including but not limited to animation, audio, video each said file being provided with a distinctive, displaceable icon, said resources further including certain user-specific data selected from: (1) one or more address books containing addresses for persons belonging to a selected class or possessing certain interests whose interests may be similar to those of the user, (2) a user-related personal database and (3) other personal data, said tools including at least preview and send functions;
(c) a short-term dynamic image database for drag-and-drop electronic image creation steps and data manipulation including handling: (1) one or more said topical background canvases and (2) one or more said topical elements, said topical elements including but not limited to text, graphics, animations, sounds and video clips to be placed upon or associated with said backgrounds;
(d) a long-term user database for storing an array of user-specific information, said database having provisions for indexing and storing any type of electronic information including one or more of: user's contact data files, user's browser-type user electronic address books and other electronic media files containing still graphics, text, data, animation, audio and video and;
(e) sufficient designated memory space to store user-related database records on messages for immediate transmission or for storage including: (1) details of every real-time or online transmission including time, site, address, message size and (2) for storing complete messages in addition to attachments being held in draft form or for transmission at a designated future date-time.

3. A unique collaboration result defined by progressive mutual agreement and the related information-exchange method between two or more individuals accomplished using at least a pair of computers interconnected by means of one or more networks and each provided with a typical internet browser, a color-display screen and input devices including at least a pointing device and a keyboard, and a third site-server-computer rigged with user-accessible graphics and text management algorithms and located at a contactable internet website, the information-exchange method comprising the steps:
(A) said first individual inputting into first computer parameters sufficient to achieve a workable network connection to said contactable website;
(B) after establishment of a workable network interconnection, first said individual further providing inputs into first computer consisting of:
(1.) a job identifier and password for a previously-stored, still-active-status and website-stored job file containing all prior work on said job, said identifier being associated with the password-secured job file as most-recently modified, or
(2.) keyboard or pointer responses to predetermined input data- or selection-field prompts displayed by said remote site sufficient to initiate, create and password-save an identified new job;
(C) first said individual further inputting into first computer inputs sufficient to produce one or more changes of said identified job file selected from:
(1.) original-input graphic or text elements, (2.) additional site-displayed graphic or site-displayed text files, (3.) additional executable program files capable of modifying any existing elements, (4.) reformatting, correcting or rewording of a text element and (5.) modifying color, appearance, position, spatial arrangement or form of a graphic element, using customized graphic and text tools provided at said contact site;
(D) first said individual further inputting into the computer command parameters to cause the site system to save said resulting job file in a designated portion of site memory and exiting from said remote site;
(E) at a subsequent point in time and during said active-interval for said job file,
(1.) said first individual communicates sufficient “password” data to said second user that latter may access said stored job on a computer,
(2.) second said individual further inputting into second computer said “password” and sufficient other selection parameters to cause said site to display said job file and permit a full range of creative information-exchange actions including but not limited to editing, printing, emailing,
(3.) said second individual further inputting text, options, elections and selections as desired to interact with said job file,
(4.) upon completion of said interaction steps, said second individual providing computer inputs sufficient to cause said site system to save changed job file in a designated portion of site memory and upon completion of the save, exiting from said remote site;
(F) subsequently said first, second or both individuals continue to interact sufficiently and sequentially with said job file until both individuals are satisfied with all aspects of the job, whereby said information-exchange process produces a unique collaboration result.

4. The system of claim 2, wherein said website system includes site-unique programs adapted to perform an array of image-generation steps, said programs providing image-manipulation capabilities further comprising:
(a) providing user with an online access to the following site-generated pages:
(a1) image creation page linked to an image database and
(a2) one or more send pages linked to said user graphics database and user's recipient addresses in said user's address book
(b) providing user with access to graphic backgrounds and elements and allowing the user to use one of:
(b1) a computer mouse and
(b2) other computer pointing device, to drag and drop said elements on the said backgrounds thereby dynamically creating electronic images;
(c) providing users with access to said send database, thereby allowing users to send said dynamically-created images to a designated recipient via email;
(d) providing user with access to his own previously created images by linking them with said user database, whereby user is provided an opportunity to edit or delete previously-created images;
(e) providing user with access to a supplemental custom address book within or linked to said user database; whereby said user may electronically send images to addresses or persons listed in said user's address book.

5. The information-exchange method of claim 3 wherein the collaboration result is a greeting card sent to one or more user-selected recipients and the information-exchange method involves a single individual creating said card by one or more of:
(a) selecting site-available graphics and text, (b) utilizing features provided by computer inputs and internet connection to generate new graphics and text, and (c) uploading files from an external source containing text or graphics to said contactable website.

6. The information-exchange method of claim 3 wherein the collaboration result is a technical graphic to specify a mechanical or architectural design and the information-exchange method involves participation from two or more individuals representing different professional disciplines, said technical graphic being created by one of more of:
(a) selecting site-available graphics, spreadsheets and text, (b) utilizing features provided by computer inputs and internet connection to generate new graphics, spreadsheets and text, and (c) uploading files from an external source containing text, spreadsheets or graphics to said contactable website.

7. The information-exchange method of claim 3 wherein the collaboration result is a gift certificate sent to a selected recipient and information-exchange method involves a single individual creating said certificate by one or more of:
(a) selecting site-available graphics and text (b) utilizing features provided by computer inputs and internet connection to generate new graphics and text, and (c) uploading files from an external source containing text or graphics to said contactable website.

8. The information-exchange method of claim 3 wherein the collaboration result is an invitation sent to a selected recipient and information-exchange method involves a single individual creating said invitation by one or more of:
(a) selecting site-available graphics and text, (b) utilizing features provided by computer inputs and internet connection to generate new graphics and text, and (c) uploading files from an external source containing text or graphics to said contactable website.
